(19) United States
(12) Patent Application Publication
(10) Pub. No.: US 2026/0031592 A1
(43) Pub. Date: Jan. 29, 2026

(54) UNIVERSAL FREQUENCY SYNTHESIZER

(71) Applicant: IMRA America, Inc., Ann Arbor, MI (US)

(72) Inventors: Kevin F. Lee, Ann Arbor, MI (US); Martin E. Fermann, Dexter, MI (US); Jacob A. Lampen, Ypsilanti, MI (US); Jie Jiang, Ann Arbor, MI (US)

(21) Appl. No.: 19/175,925

(22) Filed: Apr. 10, 2025

Related U.S. Application Data
(60) Provisional application No. 63/675,432, filed on Jul. 25, 2024.

(51) Int. Cl. H01S 3/1112; H01S 3/067; H01S 3/107; H01S 3/137

(52) U.S. Cl. CPC H01S 3/1112; H01S 3/06791; H01S 3/107; H01S 3/137

(57) ABSTRACT

Harmonically modelocked (HML) frequency comb lasers can allow an increase of the repetition rate of passively modelocked laser by up to a factor of 1000 to the frequency range of 1-40 GHz, while preserving their comb properties. An HML laser can include a reference cavity with a beam splitter that is a common mode to the reference cavity and a main cavity, while further configured for also producing an output for the HML optical frequency comb. Bulk as well as fiber reference cavities can be implemented with ultra-low expansion thermal expansion materials that allow the use of HML lasers as precision frequency references and frequency synthesizers for the microwave, mm wave and optical frequency domain. HML dual frequency combs with minimal differential noise between the two combs can reference both combs to the same reference cavity. Harmonic modelocking can also facilitate optical parametric oscillation inside the reference cavity.

### CLAIM OF PRIORITY

This application claims the benefit of priority to U.S. Provisional Appl. No. 63/675,432 filed Jul. 25, 2024 and incorporated in its entirety by reference herein.

### BACKGROUND

### Field

The present application relates generally to ultra-high stability frequency synthesizers and pulse sources.

### Description of the Related Art

Frequency synthesizers and high stability ultra-short pulse sources are ubiquitous in many areas of optical technology. Particularly attractive are systems based on frequency combs that allow anchoring of the generated frequencies or pulses in a well-defined frequency grid. Application areas include but are not limited to: sensing, machining, metrology, microwave generation, terrestrial and satellite communications and quantum computing, to name a few. For example, in free-space optical communication, it is beneficial to engage GHz level repetition rate 100 fs pulse sources to reduce the effect of atmospheric speckle in long-distance signal transmission.

To date, seven main methods for ultra-short pulse generation are used in industry: 1) modelocked fiber and solid state lasers, 2) gain switched and modelocked diode lasers, 3) electro-optic modulator (EOM) based pulse sources, 4) four-wave mixing (FWM) induced fiber pulse sources, 5) cavity soliton based sources, 6) micro-resonators (MR), and fiber microresonators (FMR). Such pulse sources can also be operational as frequency combs, meaning they can have a well-defined mode spectrum in frequency space. To date, only modelocked sources and micro-resonators (MR) can be operated as frequency combs without resorting to prohibitively complex system construction. For many application areas, the external short pulse source used for FMR is undesirable, solid-state based sources are generally considered too inflexible and bulky to be used for frequency combs and MR based frequency combs are still very difficult to construct because of their high intrinsic repetition rates, which are presently typically greater than 40 GHz, making the measurement and control of their carrier envelope offset frequency a challenge. These considerations have resulted in fiber frequency combs dominating the frequency comb application space.

### SUMMARY

In certain implementations, an apparatus comprises a harmonically modelocked (HML) laser comprising a main cavity with a first cavity round trip time T and a reference cavity with a second cavity round trip time T/N, where N is an integer. The main cavity and the reference cavity are coupled to one another. The apparatus further comprises at least one optical beam splitter within the reference cavity. The at least one optical beam splitter is configured to create a common mode substantially shared between the main cavity and the reference cavity and to produce an output for an optical frequency comb.

In certain implementations, an apparatus comprises a first cavity with a first cavity round trip time T and a second cavity with a second cavity round trip time T/N, where N is an integer. The first and second cavities are coupled to one another. The apparatus further comprises at least one optical beam splitter within the second cavity. The at least one optical beam splitter is configured to create a common mode substantially shared between the first and second cavities and to produce an output for an optical frequency comb.

In certain implementations, an optical cavity comprises a first cavity mirror and a second cavity mirror. The first and second cavity mirrors are concentric around a principal axis. The optical cavity further comprises an input beam impinging the first cavity mirror at a first angular offset from the principal axis. The optical cavity further comprises an output beam transmitted through the first cavity mirror at a second angular offset from the principal axis. The second angular offset is substantially equal to a negative of the first angular offset, wherein the optical cavity is configured as an optical reference for a modelocked laser.

In certain implementations, an apparatus comprises a harmonically modelocked (HML) laser comprising a main cavity having a first cavity round trip time T and a reference cavity having a second cavity round trip time T/N, where N is an integer. The main cavity and the reference cavity are coupled to one another, and the harmonically modelocked laser operates at a repetition rate N/T. The apparatus further comprises at least one optical beam splitter within the reference cavity. The at least one optical beam splitter is configured to create a common mode substantially shared between the main cavity and the reference cavity, wherein the harmonically modelocked laser has a repetition rate that is phase locked to an external microwave reference.

In certain implementations, a harmonically modelocked (HML) fiber laser system is configured using an external reference cavity, which provides coherent feedback to the pulses inside the main fiber laser cavity including actuators for ensuring long term stability.

In certain implementations, a dual comb system comprises two harmonically modelocked lasers, the two harmonically modelocked lasers comprising a common reference cavity.

In certain implementations, an optical parametric oscillator comprises a modelocked pump laser oscillating at a pump laser wavelength. The modelocked pump laser comprises a first cavity with a first cavity round trip time T and a second cavity with a second cavity round trip time T/N, where N is an integer. The first and second cavities are optically coupled to one another, wherein the second cavity further comprises a nonlinear crystal. The second cavity is configured to generate an output at a wavelength that is different from the pump laser wavelength.

In certain implementations, a HML fiber laser system can also be configured with a nested reference cavity located within the main fiber laser cavity and can also include one or more actuators for ensuring long term stability.

In certain implementations, the HML fiber laser system can be operated as a low noise high repetition rate frequency comb by having a mode spacing of the reference cavity that is a multiple of the cavity mode spacing of the main fiber laser cavity.

In certain implementations, the HML fiber laser system can be used as a low noise microwave source via detection of the HML repetition rate with a photodetector.

In certain implementations, the HML fiber laser system can be used as a low noise mm source via filtering out two of the HML comb modes and interfering them on a photodetector.

In certain implementations, the HML fiber laser system can be used as a low noise frequency synthesizer via filtering out individual comb modes with appropriate optical bandpass filters.

### BRIEF DESCRIPTION OF THE DRAWINGS

FIG. 1A schematically illustrates an example of a harmonically modelocked pulse train in the time domain.

FIG. 1B schematically illustrates an example of a harmonically modelocked pulse train in the spectral domain.

FIG. 2A schematically illustrates an operational principle of an example HML fiber laser with repetition rate multiplication via an integral reference cavity in accordance with certain implementations described herein.

FIG. 2B schematically illustrates a pulse evolution of a single pulse injected into an external reference cavity as used as part of an example HML fiber laser with repetition rate multiplication via the external reference cavity in accordance with certain implementations described herein.

FIGS. 3A and 3B schematically illustrate two example HML fiber lasers with relative cavity length stabilization between an external reference cavity and a main fiber cavity as well as f_{beat} and f_{ceo} stabilization in accordance with certain implementations described herein.

FIG. 3C is a flow diagram of an example method for phase locking of f_{ceo} and f_{beat} for an example HML fiber laser in accordance with certain implementations described herein.

FIG. 4A represents an actual measurement of the RF spectrum of the output of an example HML fiber laser in accordance with certain implementations described herein when interfered with a cw laser as recorded with a photodetector.

FIG. 4B represents an actual measurement of the optical spectrum of the output of an example HML fiber laser, as referred to in FIG. 4A, under different conditions.

FIG. 4C represents an actual measurement of a phase noise power spectral density (left axis) and integrated phase noise (right axis) for f_{beat} of an example HML fiber laser in accordance with certain implementations described herein.

FIG. 5 schematically illustrates another example HML fiber laser with repetition rate stabilization via an external reference cavity in accordance with certain implementations described herein.

FIG. 6 schematically illustrates another example HML fiber laser with repetition rate stabilization via an external reference cavity in accordance with certain implementations described herein.

FIG. 7A schematically illustrates an example of a bulk bi-directional reference cavity operable in transmission for an example HML fiber laser with repetition rate stabilization via said reference cavity in accordance with certain implementations described herein.

FIG. 7B schematically illustrates an example of an all-fiber bi-directional reference cavity operable in transmission for an example HML fiber laser with repetition rate stabilization via said reference cavity in accordance with certain implementations described herein.

FIG. 8 schematically illustrates another example fiber reference cavity operable in transmission for an example HML fiber laser configured as a figure eight laser with repetition rate stabilization via said reference cavity in accordance with certain implementations described herein.

FIG. 9A schematically illustrates an example of an ultra-high stability bi-directional fiber based reference cavity operable in transmission for an example HML fiber laser with repetition rate stabilization via said reference cavity in accordance with certain implementations described herein.

FIG. 9B schematically illustrates an example of an ultra-high stability bi-directional bulk reference cavity operable in transmission for an example HML fiber laser with repetition rate stabilization via said reference cavity in accordance with certain implementations described herein.

FIG. 9C schematically illustrates an example of a monolithic bulk reference cavity operable in transmission for an example HML fiber laser with repetition rate stabilization via said reference cavity in accordance with certain implementations described herein.

FIGS. 9D and 9E schematically illustrate two example HML fiber lasers with relative cavity length stabilization between an external fiber reference and a main fiber cavity, as well as actuators, in accordance with certain implementations described herein.

FIGS. 10A-10D schematically illustrate examples of bulk reference cavities operatable as a frequency reference for repetition rate stabilization of an example HML laser via said reference cavity in accordance with certain implementations described herein.

FIG. 10E schematically illustrates an example HML fiber laser comprising a V-cavity operatively connected to a nonlinear amplifying loop mirror to facilitate HML and to function as a frequency reference for repetition rate stabilization of the HML fiber laser in accordance with certain implementations described herein.

FIG. 10F schematically illustrates another example HML fiber laser comprising a monolithic V-cavity integrated with an electro-optic modulator, operatively connected to a nonlinear amplifying loop mirror to facilitate HML in accordance with certain implementations described herein.

FIG. 10G schematically illustrates an example monolithic V-cavity integrated with a lithium niobate based electro-optic modulator in accordance with certain implementations described herein.

FIG. 11 schematically illustrates an example HML frequency reference as used for ultra low phase noise microwave generation in accordance with certain implementations described herein.

FIG. 12 schematically illustrates an example HML frequency reference as used for ultra low phase noise microwave generation or as a frequency synthesizer in accordance with certain implementations described herein.

FIG. 13 schematically illustrates an example HML fiber laser configured for frequency down-conversion in accordance with certain implementations described herein.

FIG. 14 schematically illustrates an example system of two HML fiber lasers configured with a common reference cavity for dual comb operation in accordance with certain implementations described herein.

FIG. 15 schematically illustrates an example configuration of two common cavity HML fiber lasers for dual comb operation in accordance with certain implementations described herein.

FIG. 16 schematically illustrates an example HML fiber laser configured as an optical parametric oscillator in accordance with certain implementations described herein.

### DETAILED DESCRIPTION

Despite their preponderance in industry, fiber frequency combs still have some limitations, negatively impacting their application potential. One of the most severe limitations are the relatively long lengths of fiber gain media used for the construction of modelocked fiber lasers, which makes the operation of fiber frequency combs operating with a mode spacing Δf>250 MHz very difficult, since the length L of the gain medium determines the maximum mode spacing by the well-known expression (for a ring cavity modelocked at the fundamental cavity round-trip time):

$$Δ f = c / ( {n}_{idx} \times L ) , \qquad ( 1 )$$

where c is the velocity of light and n_{idx} is the fiber refractive index. Though much work has been going on to increase the repetition rate of fiber laser sources via harmonically modelocked (HML) fiber lasers (see for example: U.S. Pat. No. 5,414,725 to Fermann et al.) or to come up with other compact repetition rate pulse sources based on EOM (e.g. U.S. Pat. No. 7,239,442 to Kourogi et al.), to date, such sources suffer from large frequency noise, which has made their operation as frequency combs impossible or at least very difficult.

When it comes to the application of modelocked fiber lasers to frequency synthesizers, frequency combs also have severe limitations, since generally external cw lasers locked to a bulky ultra-high Q reference cavity are used to transfer the stability of the reference cavity to the fiber comb repetition rate and to provide a low noise microwave output (via detection of the comb repetition rate) or to reduce the phase noise of the individual comb lines. Such a system is, for example, described in X. Xie, Nature Photonics, vol. 11, pp. 44-47 (2017).

Hence, there is a need for compact, highly coherent pulse sources and frequency synthesizers with a pulse repetition rate in the range from 250 MHz-40 GHZ, where the majority of the application potential for ultra-fast pulse sources resides.

Certain implementations described herein provide compact and highly robust ultra-low noise HML fiber lasers and frequency synthesizers that can further technological developments in sensing, machining, metrology, microwave generation, terrestrial and satellite communications and quantum computing and other applications.

### Overview

Harmonically modelocked (HML) fiber lasers have been subject of many investigations (see, e.g., U.S. Pat. No. 5,212,711 to Harvey et al., '725 to Fermann et al., and U.S. Pat. No. 6,738,408 to Abedin et al., and more recently X. Cao et al., “GHz Figure-9 Er-Doped Optical Frequency Comb Based on Nested Fiber Ring Resonators,” Laser Photonics Rev. vol. 17, 230057 (2023)). Both Harvey and Cao used Fabry-Perot based sub-cavities as repetition rate multipliers, where in order to obtain stable operation for a sub-cavity of optical round trip cavity length L or equivalent cavity round trip time t=L/c:

$$t = L / c = 1 / ( {f}_{0} \times N ) = T / N , \qquad ( 2 )$$

where f₀ is the fundamental repetition rate, T is the fundamental round trip time of the modelocked fiber laser, and N is an integer with N≥1. A limitation of previously-disclosed HML fiber lasers is that they included internal sub-cavities or at most included only one actuator for repetition rate control for matching the length of the sub-cavity to the main cavity. Additional actuators for stabilizing the beat signal (obtained when interfering the modelocked laser output with an external reference laser) or for stabilizing the carrier envelope offset frequency were not included. Hence, the construction of frequency synthesizers based on HML was not considered.

In contrast, frequency synthesizers have been constructed based on both modelocked fiber lasers operating at the fundamental repetition rate, as described by T. Schibli et al. in “Phase-locked widely tunable optical single-frequency generator based on a femtosecond comb,” Opt. Lett., vol. 30, pp. 2323-2325 (2005) and D. T. Spencer et al., “An Integrated-Photonics Optical-Frequency Synthesizer,” Nature, vol. 557, pp. 81-85 (2018), respectively. Generally, the term frequency synthesizer is used in industry and science for a source that can produce a well characterized single frequency output with a pre-determined frequency. Ideally, the pre-determined frequency is also tunable in a selectable frequency range. To date, it has not been possible to employ HML for frequency synthesizers due to prevalent large levels of frequency noise because of the inability to stabilize the optical frequencies of the optical mode spectrum. Rather, only the global repetition rate or mode spacing of such sources was stabilized.

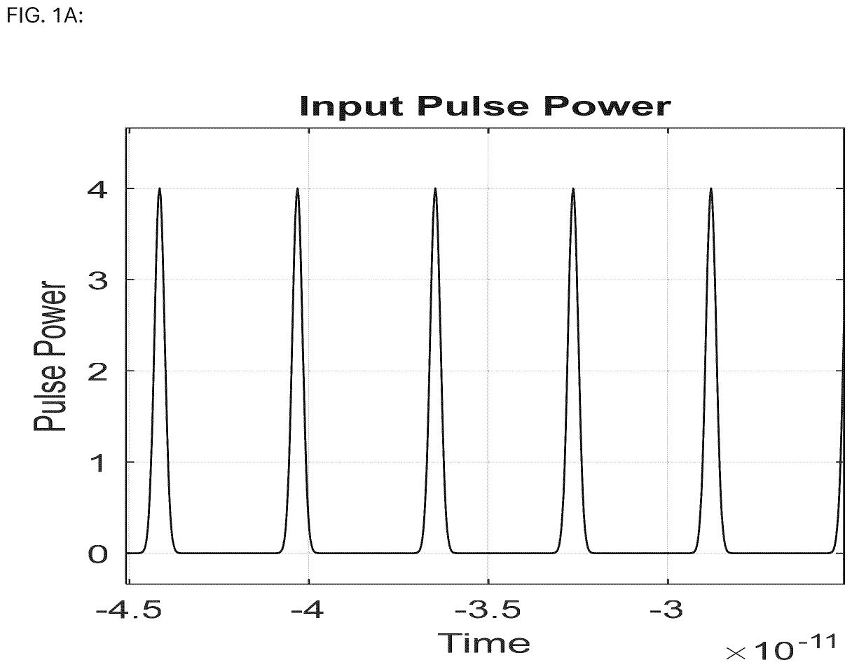

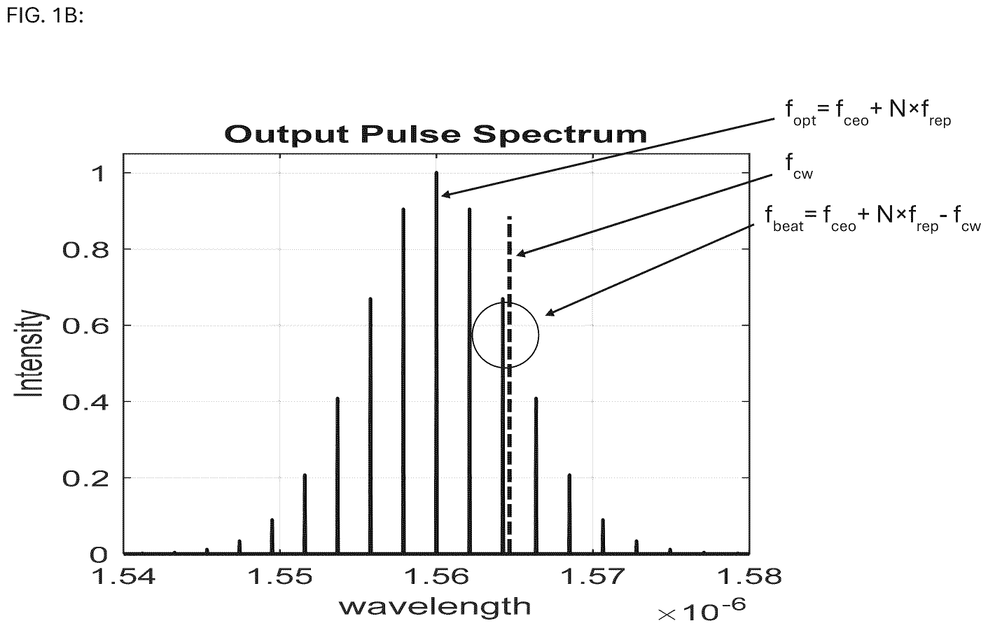

This is further illustrated in FIGS. 1A and 1B. FIG. 1A shows a conventional HML fiber pulse train in the temporal domain with pulses separated by the pulse repetition period 1/fᵣₑₚ, which is stabilized using conventional technology using, for example, only one actuator to adjust the repetition rate mismatch between fᵣₑₚ and a sub-cavity with N×f₀. FIG. 1B shows the optical spectrum of a HML frequency comb in the frequency domain, where, in addition to fᵣₑₚ, also the absolute optical frequency of at least one optical comb mode fₒₚₜ=f_{ceo}+N×fᵣₑₚ is stabilized with high precision, where f_{ceo} is the carrier envelope offset frequency and N is an integer. Similar to standard fundamentally modelocked frequency combs, the stabilization of fₒₚₜ utilizes measurement or stabilization of f_{ceo} and also the measurement or stabilization of a beat frequency f_{beat} with an external cw laser reference with frequency f_{cw}. Similar to standard fundamentally modelocked frequency combs, f_{beat} is then given by f_{beat}=f_{ceo}+N×fᵣₑₚ−f_{cw}, assuming that the beat between the cw laser with the nearest neighbor comb mode is measured, as illustrated in FIG. 1B. The simultaneous measurement or stabilization of both f_{ceo} and f_{beat} for harmonically modelocked lasers has not been possible with any previously disclosed harmonically modelocked systems. The reasons for this shortfall are numerous: for example, prevalent excessive noise of harmonically modelocked lasers, inadequate cavity design, actuators and actuator location, to name just a few.

### Examples of Ultra-Low Noise HML Lasers

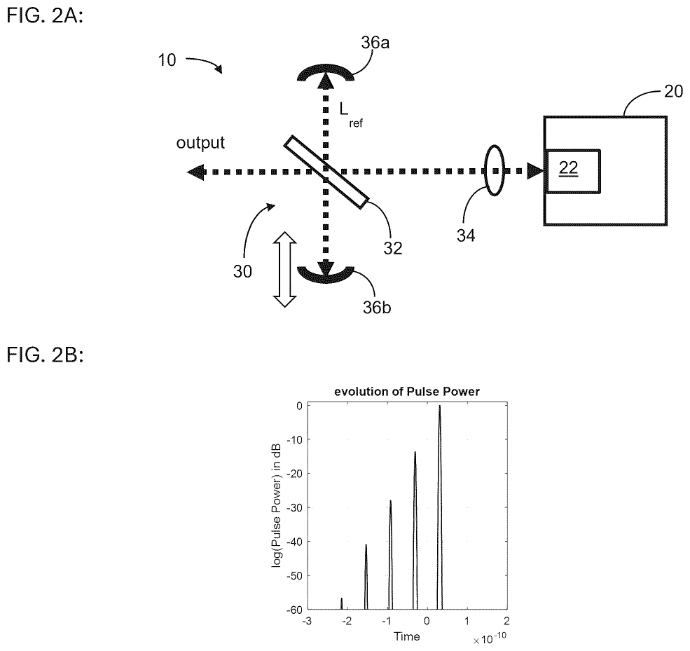

A schematic representation of an example HML design 10 is shown in FIG. 2A. A modelocked fiber laser 20, or alternatively a modelocked solid-state or diode laser, comprising a gain medium with a mode locking mechanism is merged with an integral reference cavity 30 via a beam splitter 32 and coupling optics 34. The mode locking mechanism can comprise, for example, Kerr-based fast saturable absorbers, based on fiber loop mirrors, semiconductor saturable absorbers, carbon nano-tubes, or any other modelocking mechanism. No optical isolator is used between the modelocked laser 20 and the integral reference cavity 30 bordered by mirrors 36a and 36b. Hence, the beam splitter 32 is inserted within the confines of the reference cavity 30. The mirrors 36a,b can be curved with a radius of curvature, though flat mirrors (e.g., with infinite radius of curvature) can also be used. Hence, the reference cavity 30 can provide direct optical feedback to the modelocked laser 20. The reference cavity 30 can have a round-trip length of L_{ref} and the location of mirror 36b can be adjusted (e.g., translated) so that the following relation between the cavity mode spacing Δf_{ref} of the reference cavity 30 and the cavity mode spacing of the modelocked laser 20 operating at the fundamental frequency f₀ is approximately satisfied:

$$Δ {f}_{ref} = N * {f}_{0} , \qquad ( 3 )$$

where the fundamental cavity frequency is determined by the round trip time for a pulse travelling from mirror 36a via beam splitter 32 to the modelocked laser 20 and back.

The reference cavity 30 can provide coherent feedback to the modelocked laser pulse train as illustrated in FIG. 2B; when a first pulse enters from the modelocked laser 20 into the reference cavity 30, that same pulse bounces around in the reference cavity 30, producing an output of an attenuating train of pulses as shown in FIG. 2B. This attenuated pulse train can be fed back to the main cavity 22 of the modelocked laser 20 and can coherently seed the growth of pulses separated by the reference cavity round-trip time, which can produce a pulse train at a harmonic of the modelocked laser 20. The beam splitter 32 can preferentially filter out pulse components (e.g., out of the cavity 30) that do not satisfy Δf_{ref}=N*f₀, whereas pulse components that satisfy Δf_{ref}=N*f₀ can be preferentially injected back into the main cavity 22.

As seen in FIG. 2A, such a reference cavity 30 has at least one optical beam splitter 32 inserted within the confines of the reference cavity 30, where the at least one optical beam splitter 32 directs pulses from the main cavity 22 into the reference cavity 30. By having the optical beam inside the reference cavity 30 overlapped with the beam coming from the main cavity 22 and reflected by the beam splitter 32, the beam from the main cavity 22 can overlap coherently and in-phase with the beam inside the reference cavity 30 (e.g., the beam splitter 32 is configured so the main cavity 22 and the reference cavity 30 substantially share a common spatial mode).

The beam splitter 32 can further simultaneously direct the pulses inside the reference cavity 30 and the pulses from the main cavity 22 out of the optical system (e.g., producing an output for said optical frequency comb), which can be reduced (e.g., minimized) for optimal coherent coupling between the main cavity 22 and the reference cavity 30. These two sets of pulses are well overlapped and in anti-phase, which reduces (e.g., minimizes) the output power from the system, as measured down-stream of the beam splitter 32.

This Fabry-Perot like reference cavity 30 can act as a reflective end mirror for the main cavity 22. In order to optimize harmonic modelocking, the reflectivity of this mirror can be maximized when there is high power inside the reference cavity 30. Similarly, for a loop or ring type reference cavity 30, harmonic modelocking can be optimized when the transmission through the loop is maximized when there is high power inside the cavity 30.

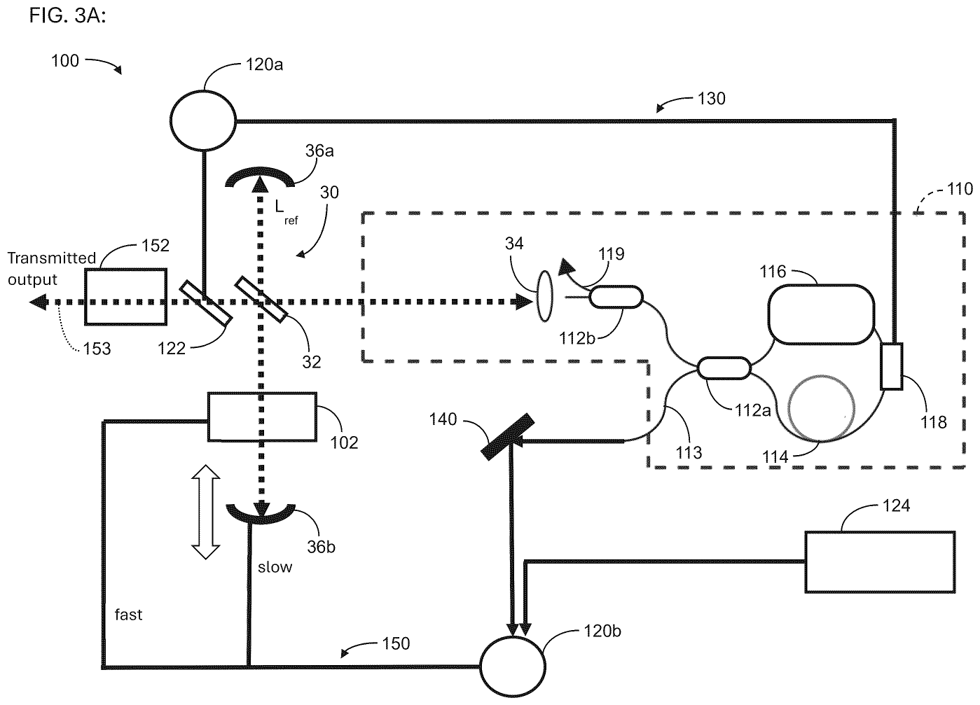

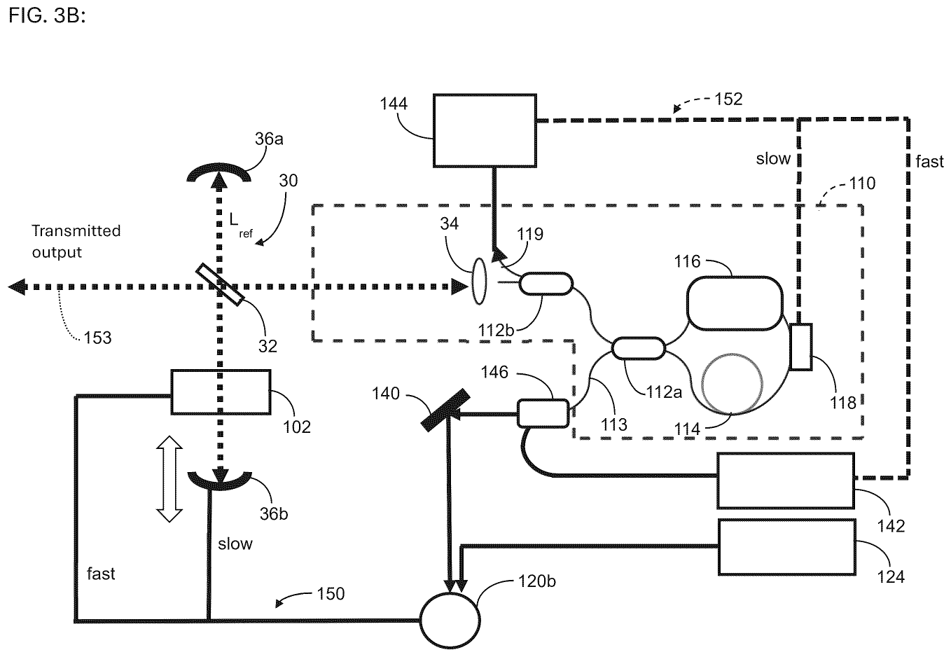

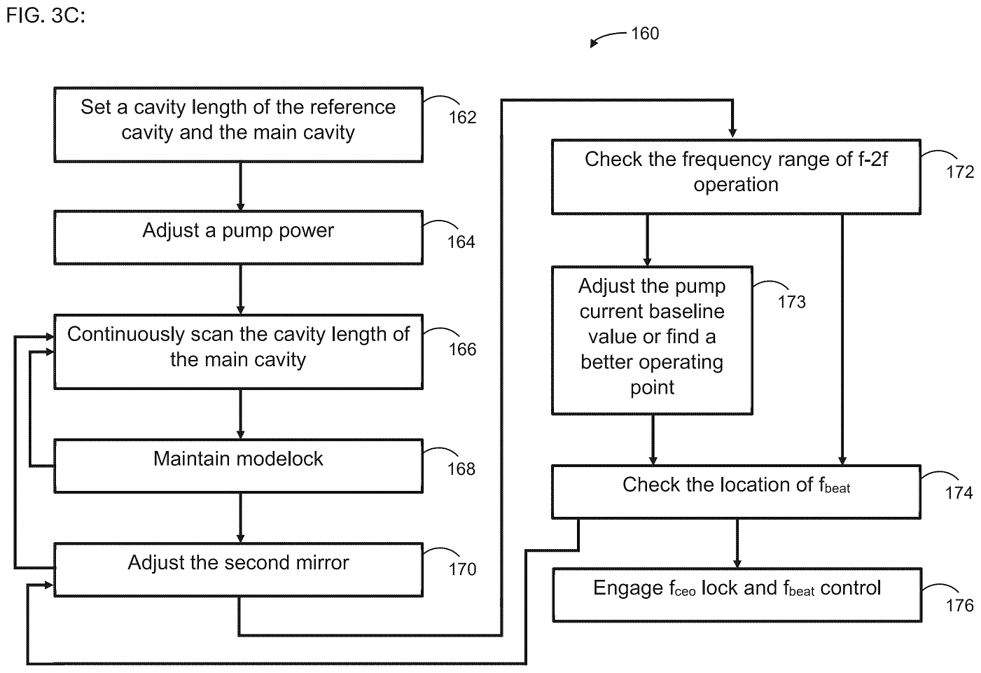

FIG. 3A schematically illustrates an example HML fiber laser 100 in accordance with certain implementations described herein. The HML fiber laser 100 is based on a nonlinear amplifying mirror (see, e.g., N. Kuse et al., “All polarization-maintaining Er fiber-based optical frequency combs with nonlinear amplifying loop mirror,” Opt. Expr., Vol. 24, Issue 3, pp. 3095-3102 (2016); U.S. Pat. No. 9,819,141 to Fermann et al.). The HML fiber laser 100 comprises an electro-optic modulator (EOM) 102 within a reference cavity 30 bounded by first and second mirrors 36a,b. In certain other implementations, the EOM 102 and the second mirror 36b are not present. In the example HML fiber laser 100 of FIG. 3A, a nonlinear amplifying loop mirror (NALM) 110 leads to the generation of short modelocked pulses (e.g., having pulse widths in a range of 50 fs to 1 ps) at the output, which are extracted via transmission through a beam splitter 32 (e.g., having a reflectivity in a range of 0.01% to 99%). The NALM 110 comprises an optical coupler 112a having a coupling ratio of x/(1−x) % (e.g., 50/50%). The NALM 110 further includes a fiber amplifier 114, for example, an erbium doped fiber amplifier (EDFA) pumped by a laser diode via another coupler (not shown), a non-reciprocal phase bias element 116, and a piezoelectric transducer (PZT) 118 configured to provide relative cavity length control. The PZT 118 can be configured to stretch the fiber length (e.g., as a fiber stretcher) and more than one fiber stretcher with different lengths can be implemented to provide fiber length actuation with different bandwidths. In certain implementations, the dispersion inside the HML fiber laser 100 is compensated by concatenating lengths of positive and negative dispersion fiber with a small overall negative (or soliton supporting) dispersion.

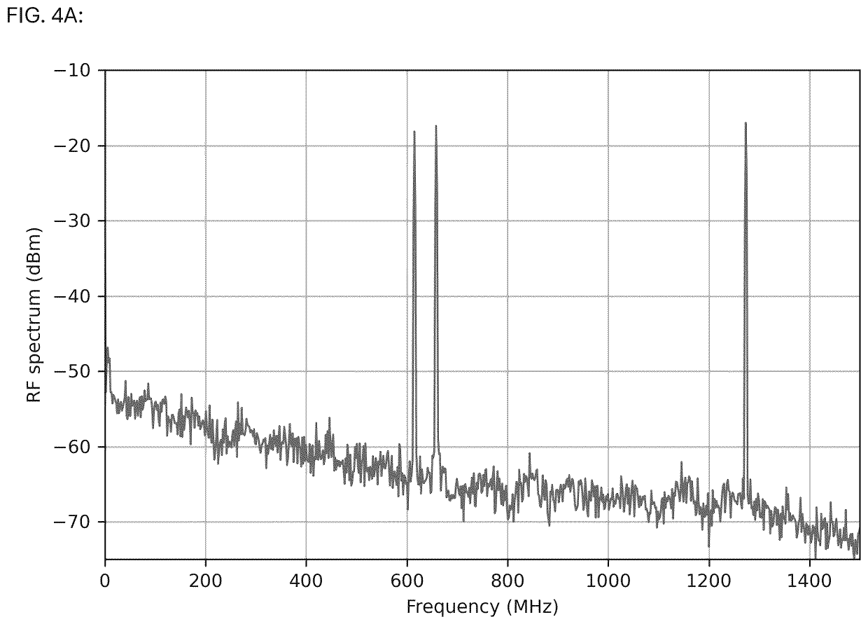

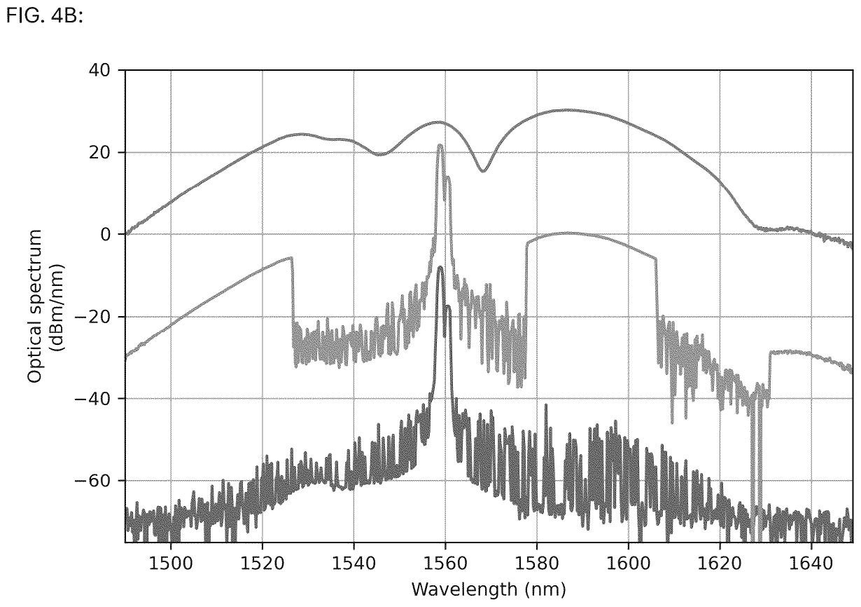

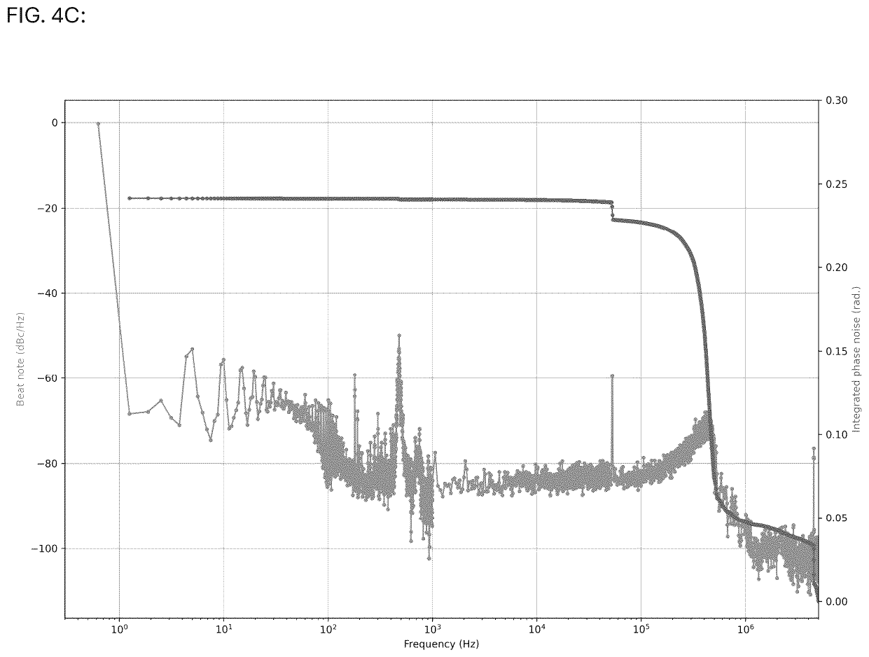

In certain implementations, the fundamental repetition rate of the HML fiber laser 100 can be in the range from 1 MHz to 250 MHz. The second mirror 36b can be moved to adjust the length L_{ref} of the reference cavity 30, and according to Eq. (3), the example HML fiber laser 100 of FIG. 3A can start harmonic modelocking from a Q-switching instability at the repetition rate corresponding to the round trip time of the reference cavity 30. A measurement of the RF spectrum (e.g., at 1 MHz resolution bandwidth) of the laser system output and detected with a first photodetector 120a is shown in FIG. 4A. For these measurements, the beam splitter 32 had a reflectivity of 40% and the HML fiber laser 100 was pumped with about 1800 mW from two polarization multiplexed single-mode diode lasers. The intermodal beat frequency shown in FIG. 4A is at 1.272 GHZ, which corresponds to the 12th harmonic of the fundamental repetition rate at 106 MHz. Beat frequencies at around 615 and 658 MHz are also visible, corresponding to the beats between the HML fiber laser 100 with an external narrow linewidth laser 124 (for example, detected with a second photodetector 120b). The signal-to-noise (S/N) ratio of these f_{beat} signals is nearly 50 dB at 1 MHz resolution, which is higher than what is typically achievable with previously-disclosed modelocked fiber frequency combs operating at the fundamental cavity round trip time. No spurious RF beats due to supermode noise are visible in FIG. 4A, which shows that the HML fiber laser 100 comprises a high-quality frequency comb. To achieve such a high quality comb and high S/N ratio, the reflectivity of the beam splitter 32 can be greater than 15%. In certain implementations, a S/N ratio greater than 25 dB at 1 MHz resolution (e.g., equivalent to 35 dB at 100 kHz resolution) can be achieved. Such a large S/N ratio is sufficient for applications in precision metrology and optical clock technology, since a S/N ratio greater than 35 dB at 100 kHz resolution can enable cycle-slip-free phase locking between laser systems or, in this example, between the present comb and an external cw laser 124.

### Exemplary Control of Cavity Length Mismatch, f_{beat} and f_{ceo}

In certain implementations, the HML fiber laser 100 is highly sensitive to any cavity mismatch between the reference cavity 30 and the main cavity 22 (e.g., with a sensitivity in the range from a few λ to λ/100). With larger optical feedback from the second mirror 36b, the wavelength sensitivity can be increased. Therefore, to control the cavity length mismatch, a feedback loop 130 (see, e.g., FIG. 3A and 3B) can be implemented which uses the power level of the optical output spectrum. The top curve of FIG. 4B shows the optical output spectrum. When filtered through a spectral bandpass filter (for example, at 1590 nm), an error signal to stabilize the relative cavity lengths can be obtained. The signal level detected by the first photodetector 120a (which can sample the output extracted from the system via a second beam splitter 122) can then be directed to a loop filter which controls the cavity length of the main cavity 22 via fiber stretching with the PZT 118 inside the NALM 110. A simulation of the pulse evolution in this HML fiber laser 100 has shown that the output pulse spectrum is sensitive to phase fluctuations between the main cavity 22 and the reference cavity 30, which can be exploited in certain implementations for the generation of an error signal for locking the cavities. A high-quality error signal can be generated, even in the presence of some Q-switching instabilities of the HML fiber laser 100, with a passive stability of the relative phases between the two cavities 20, 30 in the ms range or lower. For improved performance, the spectral density at two spectral positions can also be used as an error signal.

The action of the feedback loop 130 for adjusting relative cavity lengths is further illustrated in FIG. 4B. As explained above, the top curve of FIG. 4B shows the harmonically modelocked pulse spectrum when the two cavities 20,30 are locked to each other. The middle curve of FIG. 4B shows the harmonically modelocked pulse spectrum when the two cavities 20,30 are close to the lock point, resulting in intermittent generation of a stable pulse train and also Q-switching. The bottom curve of FIG. 4B shows the harmonically modelocked pulse spectrum when the two cavities 22,30 are further away from the lock point, resulting in a Q-switching instability. FIG. 4B shows that (for example, at 1590 nm) the spectral density of the locked system can be around 10 dB higher compared to the spectral density during Q-switching. Even in the presence of a Q-switching instability, the locking electronics can ‘capture’ the spectral shape present during harmonic modelocking and provide fine control of the cavity length mismatch in the locked state.

The PZT 118 inside the NALM 110 as shown in FIG. 3A and 3B can have a bandwidth in a range of 1 Hz to 1000 Hz, and in certain other implementations, additional actuators can be included, such as an intra-cavity waveguide or a bulk electro-optic modulator. In certain implementations, fast PZT actuators are used at or near the location of the first mirror 36a and/or the second mirror 36b to increase the feedback bandwidth. Such implementations are not separately shown.

For f_{beat} control, an output from the HML fiber laser 100, for example from the rejected output 113 from the NALM 110 as shown in FIG. 3A and 3B, can be directed via a third mirror 140 and combined with a cw laser with another beamsplitter (not shown) to interfere with the cw reference laser 124 to generate a beat signal f_{beat} in the second photodetector 120b. Other outputs can also be used, for example, extracted from an output port 119 of a second optical coupler 112b of the NALM 110 or via the second beam splitter 122. A f_{beat} feedback loop 150 can be completed with an electronic controller which compares the f_{beat} signal to a reference frequency (e.g., in the RF domain) and produces an error signal for fast and slow control of the cavity length of the short cavity. The fast control can be enabled via the EOM (e.g., a bulk intra-cavity electro-optic phase modulator) and slow control can be enabled via a PZT (not shown) which controls the position of the second mirror 36b. In certain implementations, the location of the second mirror 36b controls only the reference cavity length, but not the length of the main cavity 22. The residual phase noise spectral density of f_{beat} in dBc/Hz obtained for the example HML fiber laser 100 of FIG. 3A is further shown in FIG. 4C, which shows a phase noise for f_{beat} of 0.25 rad was measured when integrated from a side-band frequency from 6 MHz to 2 Hz.

In certain implementations, for control of f_{ceo}, an acousto-optic frequency shifter (AOM) 152 can be positioned down-stream of the output from the HML fiber laser 100 and which outputs the transmitted output 153. Alternatively, the intra-cavity gain or loss of the HML fiber laser 100 shown in FIG. 3A can be modulated. Gain control can be implemented via control of the pump power to the HML fiber laser 100 and loss control can be implemented via tilting one of the reference cavity mirrors 36a,b or via the insertion of an additional acousto- or electro-optic modulator configured for amplitude modulation (not shown) inside the reference cavity 30 (see, e.g., U.S. Pat. No. 9,698,555 to Fermann et al.).

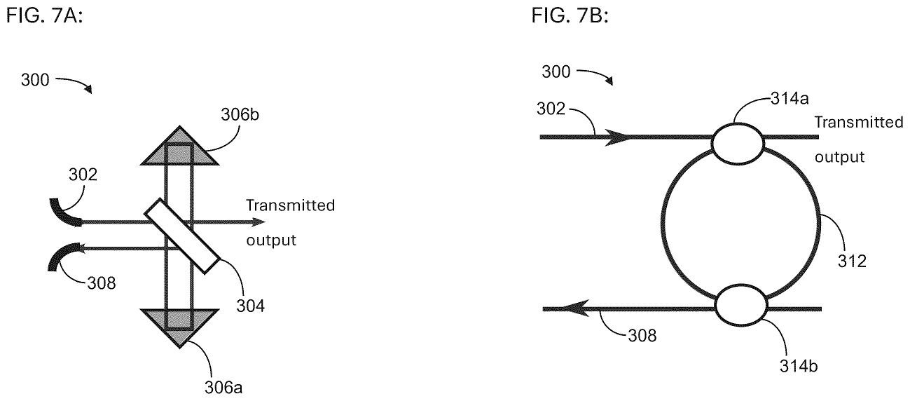

The location of the various actuators shown in FIG. 3A serve only as an example. In certain implementations, the length of the reference cavity 30 can also be controlled via controlling the location of the first mirror 36a instead of the second mirror 36b. In certain implementations, fast cavity length control can be enabled via inserting a fast phase modulator between the beam splitter 32 and the first mirror 36a or inside the fiber loop of the NALM 110. More than three actuators can also be implemented. With good stability of the reference cavity 30, having actuators inside the reference cavity 30 can be avoided, and only one or two actuators can be used to lock the main cavity 22 to the reference cavity 30. High stability reference cavities are discussed herein with reference to FIGS. 7A, 7B, 9A-9E, and 10A-10D.

In certain implementations, the phase noise of f_{beat} and f_{ceo} of a harmonically modelocked fiber laser (e.g., as shown in FIG. 2A) can be reduced (e.g., minimized) if stabilization of f_{beat} and f_{ceo} is also used to stabilize the relative cavity length mismatch between the main cavity 22 and the reference cavity 30 (e.g., due to strong coupling of f_{ceo} fluctuations to fluctuations of the relative cavity lengths). In certain such implementations, when stabilizing f_{ceo}, the relative cavity length mismatch can also be stabilized. FIG. 3B schematically illustrates an example HML fiber laser 100 that uses f_{ceo} stabilization also for cavity length stabilization in accordance with certain implementations described herein. The example HML fiber laser 100 of FIG. 3B is very similar to the example HML fiber laser 100 shown in FIG. 3A. In FIG. 3B, the example HML fiber laser 100 comprises a pump laser 142 and an f-2f interferometer 144, which generates the f-2f_{beat} frequency in the RF domain. The pump laser 142 is coupled to the NALM 110 via a wavelength division multiplexing (WDM) coupler 146. The f-2f interferometer 144 utilizes an output port 119 from the NALM 110 which is subsequently amplified via a series of optical amplifiers (not shown) to generate a sufficiently broad supercontinuum output for f-2f signal generation. The output of the f-2f interferometer 144 can be used via an f_{ceo} feedback loop 152 to generate an error signal for slow and fast control of the f_{ceo} frequency, where slow control can be enabled via control of the PZT 118 and fast control can be enabled via control of the pump current to the pump laser 142.

FIG. 3C is a flow diagram of an example method 160 for phase locking of f_{ceo} and f_{beat} for an example HML fiber laser 100 as shown in FIG. 3B in accordance with certain implementations described herein. In an operational block 162, the method 160 can comprise setting a cavity length of the reference cavity 30 and the main cavity 22 to be approximately harmonics of each other. In an operational block 164, the method 160 can further comprise adjusting a pump power such that sufficient pump power is available for an HML pulse train. In an operational block 166, the method 160 can further comprise continuously scanning the cavity length of the main cavity 22 with the PZT 118 until an operating range of the f-2f interferometer 144 encompasses the desired locking point. In an operational block 168, the method 160 can further comprise maintaining modelock by adjusting the PZT 118 until the temperature has settled, and then leave the laser 142 passively modelocked, and if modelock is lost, the method 160 can comprise returning to the operational block 166. In an operational block 170, the method 160 can further comprise adjusting the second mirror 36b to move f_{beat} to the desired frequency, and if modelock is lost, the method 160 can comprise returning to the operational block 166. In an operational block 172, the method 160 can further comprise checking the frequency range of f-2f operation. In an operational block 173, the method 160 can further comprise, if the target f-2f frequency is not centered within the stability range, adjusting the pump current baseline value or continue scanning the PZT 118 to find a better operating point in the operational block 166. In an operational block 174, the method 160 can comprise checking the location of f_{beat}, and returning to the operational block 170 if f_{beat} is not approximately equal to the desired frequency. In an operational block 176, the method 160 can further comprise, once f_{ceo} and f_{beat} are approximately equal to the desired frequency, engaging an f_{ceo} lock via feedback to the pump current (e.g., fast control) and to the PZT 118 (e.g., slow control) and engaging f_{beat} control via feedback to the second mirror 36b location (e.g., slow) and to the EOM 102 (e.g., fast).

Once f_{ceo} and f_{beat} are phase locked, long-term cavity length matching can also be implicitly ensured. The example HML fiber laser 100 shown in FIG. 3B can also include a temperature controlled box (not shown) with additional vibration damping in order to avoid large perturbations of cavity length mismatch, which the actuators may not be able to respond to fast enough. Locking of f_{ceo} and f_{beat} (see, e.g., example method 160) can involve four steps: 1) scanning of the cavity length of the main cavity 22 with the PZT 118 to observe an f-2f signal; 2) since an f-2f signal can be observed at cavity length mismatch intervals of λ, continue scanning the PZT 118 until the observed f-2f frequency is approximately at the desired location; 3) scanning the cavity length of the reference cavity 30 until the f_{beat} signal is also approximately at the desired frequency; and 4) engaging the f_{ceo} lock and the f_{beat} lock. Multiple iterations can be used to ensure that the HML fiber laser 100 is phase locked at the desired frequencies.

There can be enough crosstalk between the actuators for f_{ceo} or f_{beat} control that the HML fiber laser 100 can be stabilized with various assignments of actuators to diagnostic signal. For example, switching the main cavity 22 to stabilize f_{beat} and the reference cavity 30 to stabilize f_{ceo} can also be used. The optimal assignment of actuators to diagnostic signal can change depending on the actuator responses, and types of noise found in a particular system.

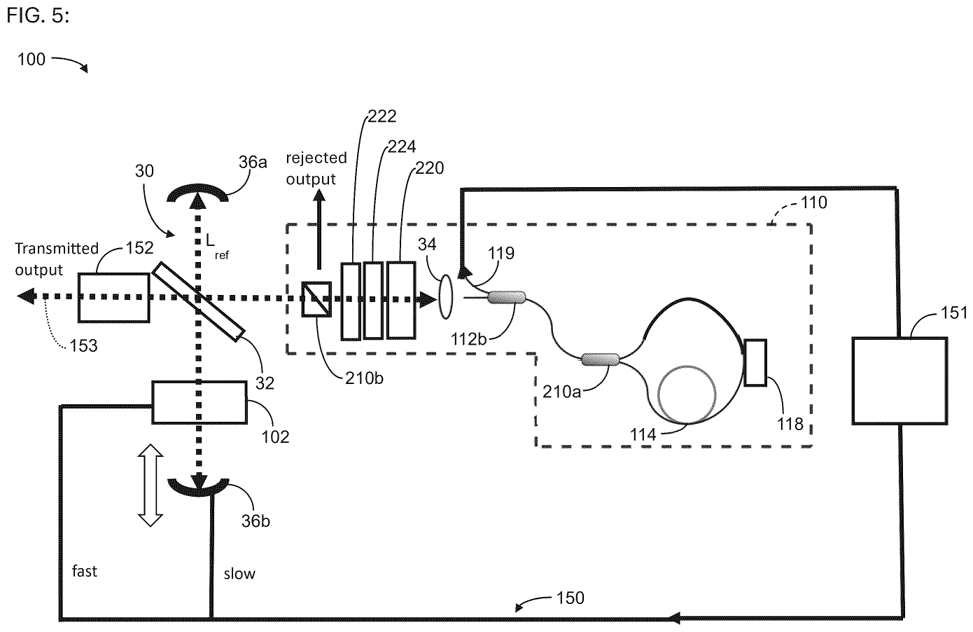

For commercially viable systems, certain implementations are configured to reduce the pump power utilized for a certain laser configuration. The power for harmonic modelocking can, for example, be lowered by the use of lower doped fibers and more efficient fiber amplifiers. Another alternative for the reduction of power consumption is shown in FIG. 5, where the x/1−x (e.g., 50/50) optical coupler 112a inside the NALM 110 of FIG. 3A is replaced with a polarization beam splitter 210a. The nonlinear phase delay to saturate the nonlinear reflectivity of the NALM 110 incorporating the polarization beam splitter 210a can be substantially lowered, which in turn can reduce the power utilized for the HML fiber laser 100. To compensate for the polarization rotation inside the NALM 110, a Faraday rotator 220 can be inserted as well. The additional insertion of a λ/2 waveplate 222 and a λ/4 waveplate 224, as shown in FIG. 5 can allow for adjustment of the nonlinear saturation power of the NALM 110. Control of f_{ceo}, f_{beat} and the relative cavity lengths can then be performed similarly, where the rejected output 113 can be obtained from the polarization beam splitter 210b. In FIG. 5, for simplicity, an example implementation of only one f_{beat} feedback loop 150, incorporating an electronic proportional-integral-derivative (PID) controller 151 is depicted.

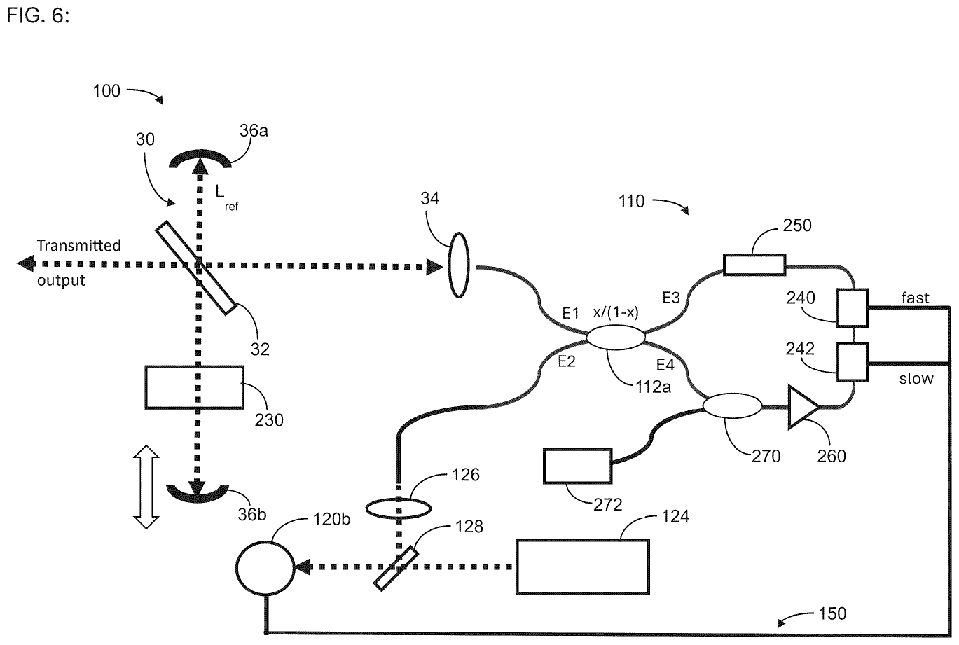

The example HML fiber lasers 100 shown in FIGS. 3A, 3B, and 5 can be highly sensitive to any cavity mismatch between the reference cavity 30 and the main cavity 22 and precision cavity length control can be utilized. FIG. 6 schematically illustrates another example HML fiber laser 100 (based on the example HML fiber laser 100 of FIG. 3A) which is only weakly dependent on cavity length mismatch in accordance with certain implementations described herein. As shown in FIG. 6, a switch 230 (e.g., mechanical shutter; optical switch) can be initially fully open to induce intermittent HML output with a spectrum similar to that shown by the middle curve of FIG. 4B. The switch 230 can then be adjusted to substantially reduce the feedback from the second mirror 36b (or to reduce the Q factor of the reference cavity 30), which can produce a HML pulse train which is far less sensitive to cavity length mismatch compared to what is possible with the switch 230 open. Example switches can include at least one of the following: a mechanical shutter, a mems mirror inserted between the beam splitter 32 and the second mirror 36b, an acousto-optic modulator, a polarization beam splitter and a rotatable quarter waveplate. In certain implementations, an EOM phase modulator 240, as shown in FIG. 6, can be modulated at approximately the desired repetition rate of the HML fiber laser 100 which can be beneficial in initiating HML output with a reduced (e.g., minimized) amount of supermode noise. In certain implementations, as shown in FIG. 6, the second photodetector 120b is configured to generate a beat signal f_{beat} from interference of a signal from the NALM 110 derived from coupler 112a and lens 126 and a signal from a cw reference laser 124 via a second beam splitter 128.

A transition from intermittent HML to HML can be random and several shutter/switch cycles can be utilized to ensure the generation of a HML pulse train. However, switching the switch 230 between open and partially closed states can be performed at frequencies up to tens of Hz or even tens of kHz and therefore, HML pulse trains can still be reliably generated in a very short time. Monitoring of the RF power at the desired harmonic, as well as at undesired sub-harmonics, can then be used as a reliable indicator of whether or not HML output is obtained with a partially closed switch 230. Once HML output is obtained, in the absence of perturbations, the HML fiber laser 100 can continue to operate at the correct repetition rate and the EO modulator 240 can be turned off. With good thermal control (e.g., control of the system temperature to around 10 mK), the HML fiber laser 100 shown in FIG. 6 can be passively stable (e.g., no control of the cavity length mismatch between the reference cavity 30 and the main cavity 22 is used for ensuring HML output). Such passively stable HML systems can be useful as a high repetition rate femtosecond pulse source, for example, for applications in free-space optical communication. For example, by mounting the second mirror 36b onto a PZT, the repetition rate of the HML fiber laser 100 can further be locked to a microwave reference. For added stability, the optical spectrum out of the HML fiber laser 100 can further be monitored and used for slow feedback to ensure the relative cavity lengths do not drift apart. In certain implementations, the feedback level from the second mirror 36b can remain fixed and reliable and self-starting HML operation can be obtained. Alternatively, the reflectivity of the beam splitter 32 can be selected for optimum self-starting operation.

In certain implementations, f_{beat} can be controlled with a PZT 242, as shown in FIG. 6, as well as the EO phase modulator 240 inside the NALM 110 fiber loop, allowing for a relatively simple system construction. In certain implementations, the EO phase modulator 240 can serve two functions: 1) facilitating the onset of pulses at the correct repetition rate and 2) allowing rapid modulation of the cavity length 20 for fast f_{beat} control. In certain implementations, f_{ceo} control can then also be provided via intra-cavity gain or loss control, as discussed herein with respect to FIG. 3A.

While the HML fiber lasers 100 in FIGS. 3A-3B, 5 and 6 are examples of different cavity configurations which can perform similar functions, other cavity configurations are also compatible with certain implementations described herein. For example, FIG. 7A schematically illustrates an example sub-cavity 300 that is bi-directional in accordance with certain implementations described herein. The example sub-cavity 300 can comprise bulk optical components that can be used in transmission, for example, as part of a ring-cavity or within the loop section of the NALM 110 shown in FIGS. 3A-3B, 5 and 6. As shown in FIG. 7A, the sub-cavity 300 can be terminated by first and second retro-reflectors 306a,b. The input port 302 of the NALM 110 can be directed to a beam splitter 304 and after reflection from the first retro-reflector 306a, the output 308 can be directed back into the NALM 110 after a second reflection from the beam splitter 304. The beam splitter 304 can have a reflectivity in a range of 0.01% to 99%. As described with respect to FIGS. 2A-2B, the function of the beam splitter 304 can be to filter out pulse components (e.g., out of the cavity 20 with the beam path labelled trans. output) that do not satisfy Δf_{ref}=N*f₀, whereas pulse components that satisfy Δf_{ref}=N*f₀ are injected back into the main cavity 22. The sub-cavity 300 of FIG. 7A is bi-directional and can therefore also be used by reversing the input/output directions that go to the NALM 110.

FIG. 7B schematically illustrates another example sub-cavity 300 that is all-fiber in accordance with certain implementations described herein. The example sub-cavity 300 of FIG. 7B is similar to that of FIG. 7A, but the beam splitter 304 and the retro-reflectors 306a,b are replaced with a ring cavity 312 (e.g., fiber loop) and two couplers 314a,b, each of which can have a coupling ratio in a range of 0.01% to 99%. The sub-cavity 300 shown in FIG. 7B can be used for generating pulse trains at repetition rates greater than about 1 GHZ, and repetition rates greater than 10 GHz using highly compact fiber loops (e.g., fiber knots). Such high repetition rates can be achieved since the increased intra-cavity power within the sub-cavity 300 can increase the nonlinear phase delay for the HML pulses. Since stable pulse operation in a passively modelocked laser can be enabled by a certain minimum nonlinear phase delay for the pulses, the nonlinear sub-cavity 300 can facilitate preservation of a large nonlinear phase delay at very high repetition rates and the reflectivity of the NALM 110 can saturate at relatively small pulse energies. Even larger nonlinear phase delays can be obtained by using a micro-resonator instead of a fiber loop as a ring or sub-cavity. For example, a microresonator can replace the fiber ring cavity 312 shown in FIG. 7B (e.g., the micro-resonator can be configured with two bus-waveguides, instead of the linear fiber sections shown in FIG. 7B, to couple the light in and out of the micro-resonator).

The relative lengths between the example sub-cavities 300 shown in FIGS. 7A and 7B and the major cavity (not shown) can be conveniently controlled with feedback loops as discussed herein with respect to FIGS. 3A, 3B, and 5. For example, spectral components of the system output can be used as an error signal and actuators (e.g., PZTs; EO modulators) can be included into the sub-cavities 300, as shown in FIG. 3A, or the main cavity 22, as shown in FIG. 2A, for precision length control.

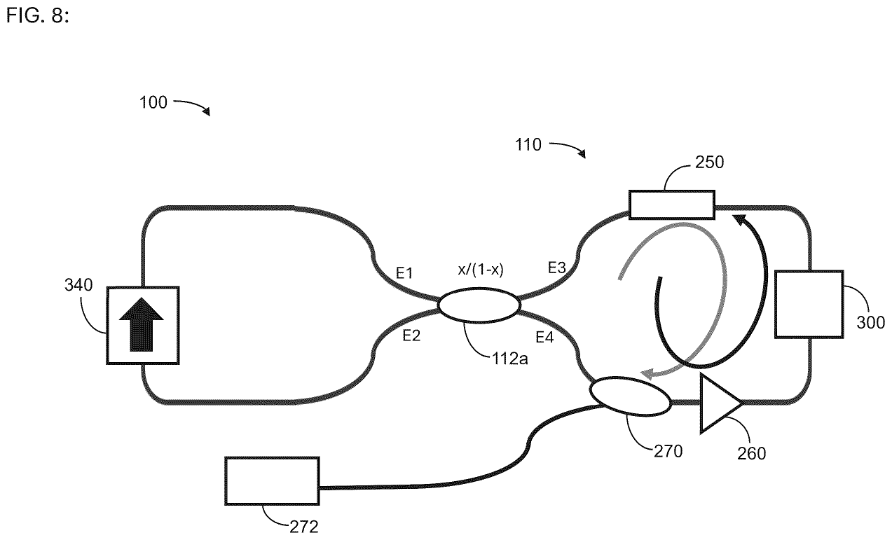

With sub-cavities 300 operational in transmission, ring-cavities or nonlinear loop mirrors configured in a figure eight (F8) configuration can also be used for HML. FIG. 8 schematically illustrates an example HML fiber laser 100 with a F8 laser (F8L) configuration in accordance with certain implementations described herein. In certain implementations the F8L configuration allows a minimization of the nonlinear phase delay used for saturation of the reflectivity of the NALM 110 (e.g., similar to what was discussed herein with respect to FIG. 5), and can be implemented to lower the pulse energy used for operation at very high repetition rates. The example F8L configuration shown in FIG. 8 comprises the NALM 110 on the right hand side of a 4-port coupler 112a. Uni-directional propagation between coupler leads E1 and E2 can be ensured by an isolator 340. The coupler ratio x/(1−x) of the coupler 112a can be in a range of 5/95% to 50/50%. The NALM 110 can comprise a non-reciprocal phase shifter (NRP) 250 configured to produce a linear phase bias between the two counter-propagating pulses inside the NALM 110, an amplifier 260 located asymmetrically inside the NALM 110, and a sub-cavity 300 as discussed herein with respect to FIGS. 7A and 7B. The NALM 110 can be pumped via a coupler 270 by a pump laser 272, and additional PZT fiber stretchers and EO modulators can also be included (not shown) for fiber length adjustment. The NALM 110 of the HML fiber laser 100 shown in FIG. 6 also includes an NRP 250, amplifier 260, coupler 270, and pump laser 272 as shown in FIG. 8.

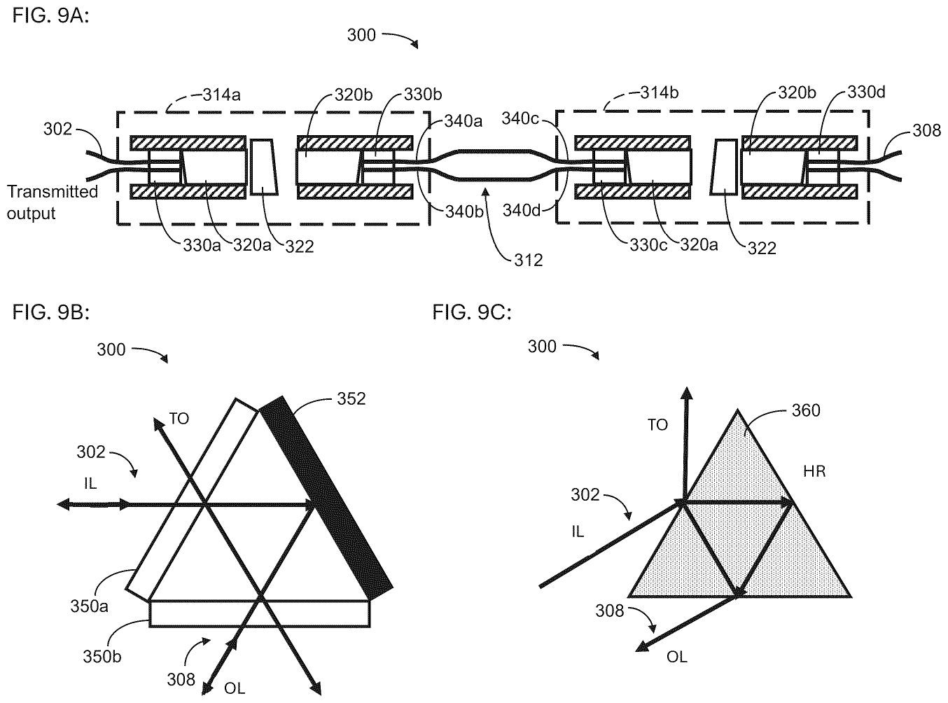

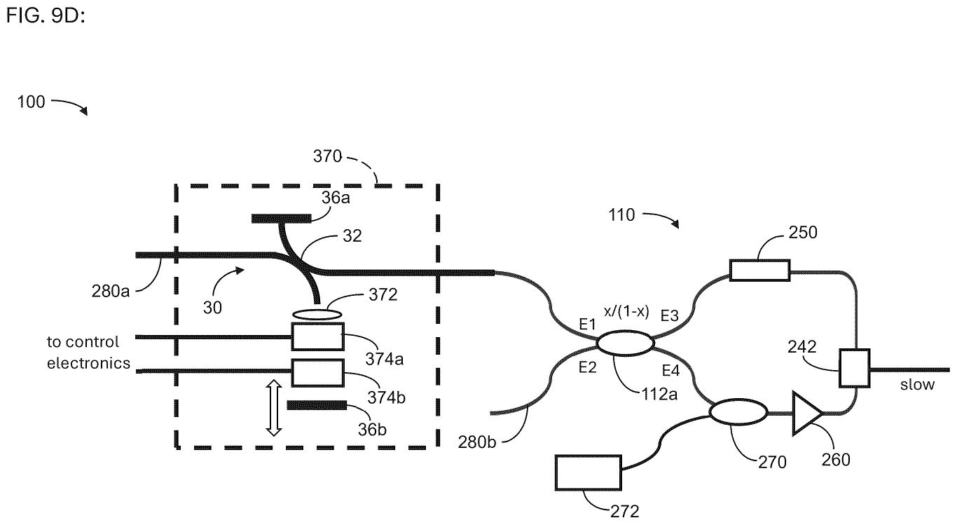

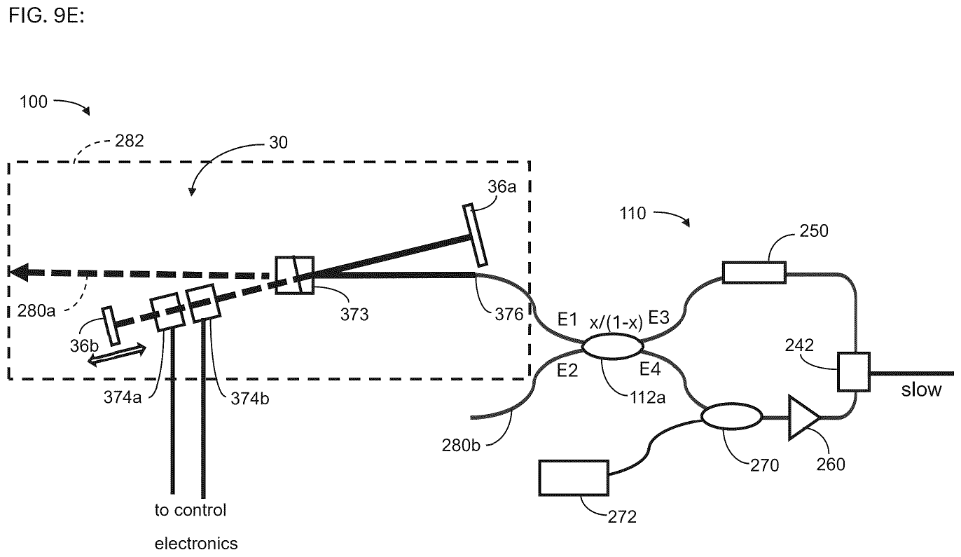

FIGS. 9A-9C schematically illustrate various example sub-cavities 300 in accordance with certain implementations disclosed here. The sub-cavity 300 of FIG. 9A is substantially equivalent to the sub-cavity 300 of FIG. 7B and uses a nonlinear fiber cavity for generating HML output. At least one of the two couplers 314a,b of the sub-cavity 300 of FIG. 9A can comprise a dual fiber 4-port coupler based on standard low cost fiber components as used in optical communication. In certain implementations, at least one of the two couplers 314a,b comprises a beam splitter 322 and two gradient-index (grin) lenses 320a,b (e.g., approximately quarter-period grin lenses) on either side of the beam splitter 322. In certain other implementations, at least one of the two grin lenses 320a,b is replaced by a collimating lens (not shown). As shown in FIG. 9A, the first coupler 314a comprises a first dual core fiber 330a (e.g., twin core fiber) configured to be the input port 302 to the first coupler 314a from the NALM 110 and the trans. output from the first coupler 314a, and a second dual core fiber 330b (e.g., twin core fiber) configured to be a first port 340a of the ring cavity 312 and a second port 340b of the ring cavity 312. Also, the second coupler 314b comprises a third dual core fiber 330c (e.g., twin core fiber) configured to be a third port 340c of the ring cavity 312 and a fourth port 340d of the ring cavity 312 and a fourth dual core fiber 330d (e.g., twin core fiber) configured to be an output 308 back into the NALM 110. Note that the fiber ring cavity 312 is shown in FIG. 9A with the core separation between the two cores increased for illustrative purposes only. In practice, a section (e.g., a single section) of dual-core fiber can be used for the ring cavity 312, in which the two cores are spatially separate from one another. The inputs and outputs of the dual core fiber can be spatially separated only upstream and downstream of the device, as shown in FIG. 9A, for easy splicing to external fiber pigtails. In certain implementations, the second and third dual core fibers 330b,c and the ring cavity 312 can be replaced with a single twin-core fiber section.

The input from the NALM 110 then can be injected, for example, into the input port 302 of the dual core fiber 330a and collimated with the quarter period grin lens 320a, and the beam splitter 322 can then direct the signal via the second grin lens 320b into the fiber ring cavity 312 and the beam splitter 322 of the first coupler 314a can also direct the transmitted output out of the fiber ring cavity 312. The fiber ring cavity 312 can be bounded by the beam splitters 322 of the first and second couplers 314a,b. The two grin lenses 320a,b of the second coupler 314b can perform similar functions compared to the two grin lenses 320a,b of the first coupler 314a. The output 308 from the fiber ring cavity 312 can be taken from one of the fiber ends of the dual core fiber 330d and can be directed back into the NALM 110. The configuration of FIG. 9A can be configured to facilitate the use of very small lengths of fiber for a sub-cavity, as suitable for repetition rates in a range of 1 GHZ to 10 GHZ.

FIG. 9B schematically illustrates another example sub-cavity 300 in accordance with certain implementations described herein. The sub-cavity 300 of FIG. 9B can be operated in transmission and substantially equivalently to the sub-cavity 300 shown in FIG. 7A. Instead of retro-reflectors 306a,b, the sub-cavity 300 of FIG. 9B comprises two beam splitters 350a,b and a total reflector 352. In FIG. 9B, the input port 302 of the NALM 110 is designated as IL, the transmitted output as TO, and the output 308 back into the NALM 110 as OL. The sub-cavity 300 can be bi-directional and can then be used within the loop section of the NALM 110 for HML output. For bi-directional operation, port IL can also serve as the port that directs the counter-directional pulses back into the NALM 110, whereas OL can serve as the port that receives the input from the counter-directional pulses from the NALM 110. In certain implementations, the sub-cavity 300 as shown in FIG. 9B can be made fully monolithic for a maximum in stability, as schematically illustrated by FIG. 9C. In certain implementations, the two beam splitters 350a,b and the total reflector 352 are replaced with a prism 360 with the outside surfaces of the prism providing the reflecting or partially reflecting surfaces. In the example sub-cavity 300 shown in FIG. 9C, the polarization of the input pulses can be chosen to be in the S-direction to increase the reflectivity of the prism surfaces. One surface of the prism 360 can be HR coated if only uni-directional operation is desired, as shown. For bi-directional operation, all surfaces can remain un-coated. Other geometries for monolithic reference sub-cavities 300 can be used.

Highly monolithic cavities can provide a maximum in stability, with only limited flexibility. FIG. 9D schematically illustrates an example HML fiber laser 100 in which a compromise between these two conditions is provided in accordance with certain implementations described herein. The reference cavity 30 is substantially equivalent to the reference cavities 30 shown in FIGS. 3A, 3B, or 6, in that the reference cavity 30 comprises and is bounded by first and second mirrors 36a,b. The beam splitter 32 comprises a fiber-based beam splitter, as compared to the beam splitter 32 of FIGS. 3A, 3B, and 6 which comprises a bulk-optic beam splitter. A first output 280a (e.g., equivalent to the transmitted output 153 in FIG. 3A) can couple the light out from the coupled cavity system that is out of phase, and a second output 280b (e.g., equivalent to the rejected output 113 of FIG. 3A) can couple the rejected light out from the NALM 110. As in FIG. 3A, the first output 280a or the second output 280b can further be used for feedback control, which is not depicted in FIG. 9D. The reference cavity 30 of FIG. 9D is part of a fiber sub-assembly 370, which further comprises a collimating lens 372 and a plurality of actuators 374 for f_{ceo} and f_{beat} control, the plurality of actuators 374 comprising a first actuator 374a (e.g., EOM) and a second actuator 374b (e.g., EOM), for example, as discussed herein with respect to FIG. 3A. The second mirror 36b can further be mounted onto a PZT controller (not shown) for slow repetition rate control or for slow control of the relative lengths of the main cavity 22 and the reference cavity 30. Operation at a fixed repetition rate can then, for example, be achieved by control of the reference cavity length via the second mirror 36b. The fiber sub-assembly 370 can be integrated into a very small form factor and can be constructed with minimum sensitivity to vibrations. Moreover, since the thermal expansion coefficients of the main cavity 22 and the reference cavity 30 can be approximately matched, very stable system construction can be achieved.

FIG. 9E schematically illustrates another example HML fiber laser 100 comprising a reference cavity 30 in accordance with certain implementations described herein. The NALM 110 in FIG. 9E can be the same as in FIG. 9D, but instead of the transmissive beam splitter 32 of FIG. 9D, the reference cavity 30 comprises a reflective collimator/beam splitter (CO/BS) assembly 373. As in FIG. 9D, a first output 280a can couple out the out-of-phase components of the HML fiber laser 100, and the second output 280b can output the rejected output from the NALM 110 which can also be used for feedback control, which is not depicted in FIG. 9E. Also, instead of an all-fiber reference cavity 30, the reference cavity 30 of FIG. 9E comprises a combination of fiber and bulk optic components (e.g., propagation in fiber and in free-space is used). The CO/BS assembly 373 can be constructed from micro-optics and can collimate the beam from the fiber pigtail 376 attached to port E1 and can reflect a small portion of that beam to the first mirror 36a. The reflectivity of the CO/BS assembly 373 can be in a range of 10% to 50%, though other values are also possible. Free-space beams are indicated with dashed lines. The first mirror 36a can also be mounted on a mechanical stage for additional repetition rate adjustment. The beam transmitted through the CO/BS assembly 373 can then be directed to the second mirror 36b, which can be mounted on a PZT (not shown) and a stage (not shown) for medium and slow bandwidth repetition rate adjustment. The first and second actuators 374a,b can be further inserted for high bandwidth repetition rate adjustment and high bandwidth loss adjustment in the reference cavity 30, which can be used for high bandwidth f_{ceo} control of the HML fiber laser 100. This example HML fiber laser 100 can be very compact and low cost, and can provide frequency combs operating at repetition rates of 1 GHz and higher. In certain implementations, a sub-assembly 282 contains the integral reference cavity 30 (e.g., including the first and second mirrors 36a,b, CO/BS assembly 373, and first and second actuators 374a,b) in a relatively small package.

While the example HML fiber lasers 100 of certain implementations comprise a nonlinear amplifying loop mirror as the main modelocking mechanism, other modelocking mechanisms can also be used in certain other implementations, such as a standard loop mirror without in-loop amplifier, or any type of saturable absorber (e.g., described in U.S. Pat. No. 7,088,756 to Fermann et al.; including carbon nano-tubes, etc.).

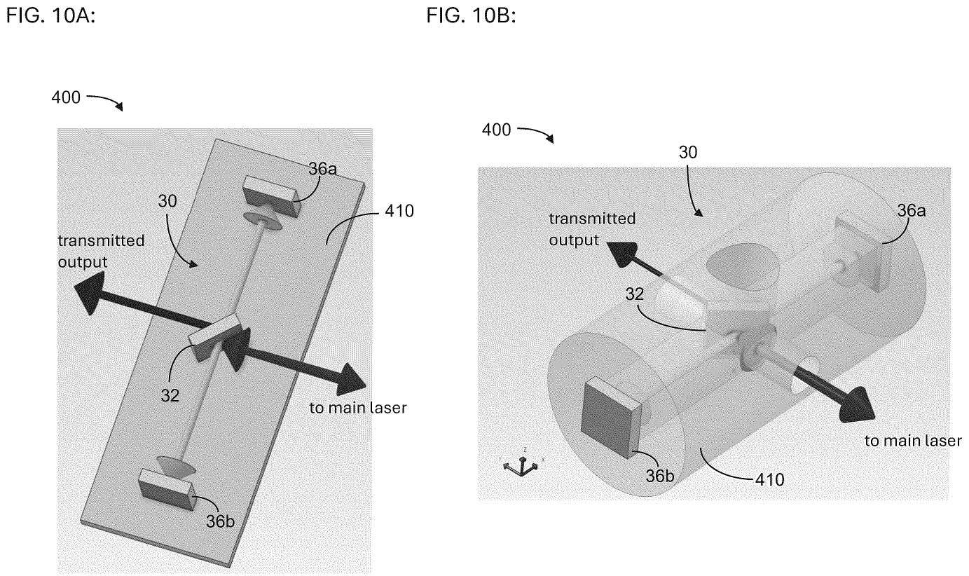

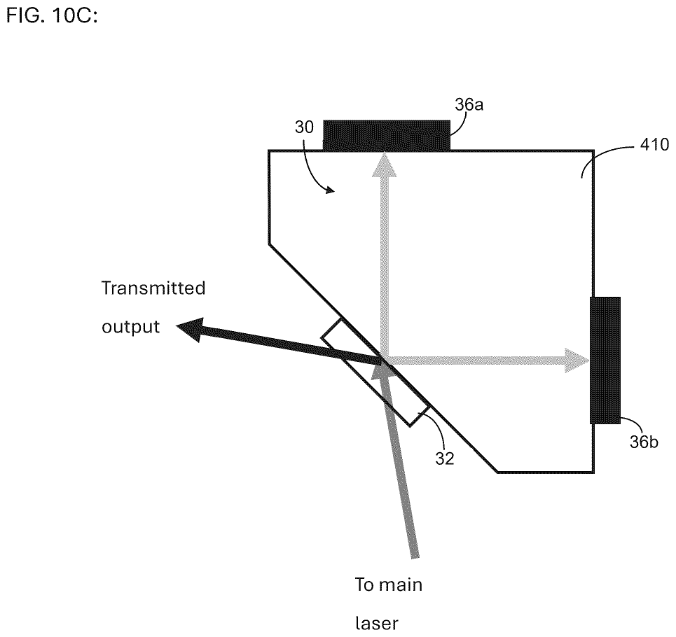

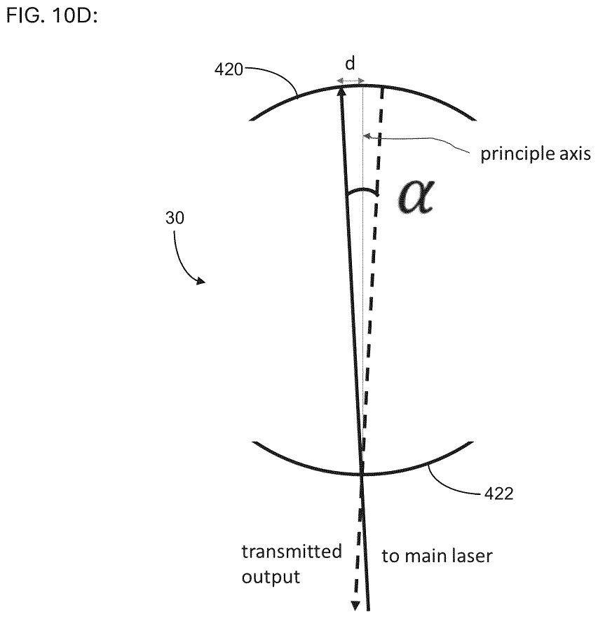

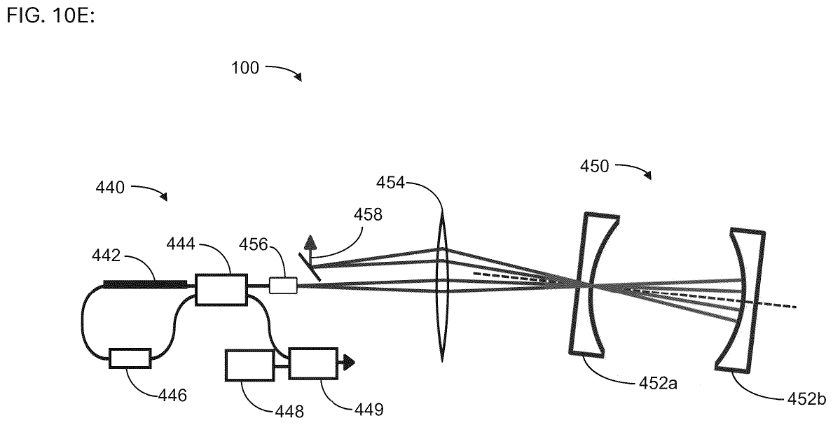

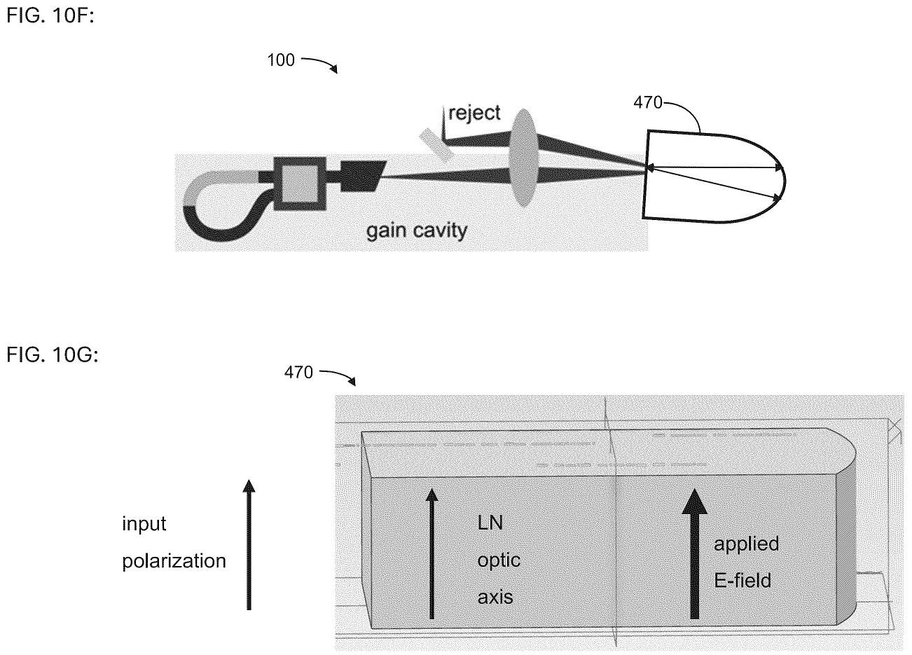

In certain implementations, an HML fiber laser 100 as described herein is configured to be used as precision frequency references. FIGS. 10A-10C schematically illustrate example frequency references 400 based on a HML fiber laser 100 (e.g., similar to what is described herein with respect to FIGS. 2A-2B, 3A, 3B, and 5) in accordance with certain implementations described herein. In FIGS. 10A-10C, the first and second mirrors 36a,b, and the beam splitter 32 are all mounted on a zero-thermal expansion substrate 410 (e.g., spacer) which can comprise, for example, ULER available from Corning of Corning NY or Zerodur® available from Schott North America, Inc. of Rye Brook NY. The reference cavity 30 shown in FIGS. 10a-10C can be connected to the main cavity 22 via a beam splitter 32, as discussed herein with respect to FIGS. 2A-2B, 3A, 3B, and 5, and the transmitted light out of the reference cavity 30 can be obtained also via the beam splitter 32. Use of a zero-thermal expansion material for the substrate 410 can improve the frequency stability of the HML fiber laser 100, allowing for generation of an ultra-stable full frequency comb with individual comb linewidths less than 10 Hz and even less than 1 Hz, without the attachment of an external reference cavity (e.g., an external reference cavity as used in conventional frequency comb technology). To ensure ultra-high frequency stability, the reference cavity 30 can be used as the frequency reference and the main cavity 22 can be locked to the reference cavity 30 using appropriate fiber stretchers and modulators in the main cavity 22.

For additional stability, another substrate (not shown) can also be attached to the top of the first and second mirrors 36a,b in FIG. 10A and to the side-walls, leaving holes for the input and output optical beams. The holes can also be covered with optical windows and the reference cavity 30 can be evacuated for enhanced stability. As shown in FIGS. 10B and 10C, the substrate 410 can comprise a hollow block (e.g., comprising ULE® or Zerodur®) configured to be used as an ultra-high-stability spacer. For example, the first and second mirrors 36a,b can be attached to the block via optical contact. The substrate 410 can also be designed with holes to allows positioning and fixing of the beam splitter 32 inside. To avoid potential instabilities due to the beam splitter 32 positioned between the first and second mirrors 36a,b, certain implementations can have the beamsplitter 32 located at a periphery of the substrate 410 (e.g., spacer block), as shown in FIG. 10C. The substrate 410 of FIG. 10C can include hollow sections for beam propagation (e.g., as shown in FIG. 10B). The first and second mirrors 36a,b and the beam splitter 32 can be attached to the substrate 410 via optical contact (e.g., for maximum stability). To increase the fabrication tolerances of the L-shaped reference cavity 30 of FIG. 10C (e.g., having an angle of about 90 degrees between the two beams inside the reference cavity 30), at least one of the three mirrors (e.g., the first mirror 36a, the second mirror 36b, and the beam splitter 32) can be curved with a finite radius of curvature.

In certain implementations, a V-shaped reference cavity 30 can be used, where the angle between the two beams inside the reference cavity 30 is less than 90 degrees. Ultra-stable V-shaped cavities 30 have previously been used, for example, as frequency references to reduce the linewidth of cw lasers (see, e.g., N. Jobert et al., “High stability in near-infrared spectroscopy: part 2, optomechanical analysis of an optical contacted V-shaped cavity,” Appl. Phys. B. 128:56 (2022)).

However, to manufacture V-shaped ultra-stable cavities, conventional fabrication techniques used for ultra-stable reference cavities 30 may not be applicable, since conventional reference cavities typically only use two mirrors. FIG. 10D schematically illustrates an example V-shaped reference cavity 30 comprising a reflector 420 (e.g., mirror) and a beam splitting mirror 422 in accordance with certain implementations described herein. Such a reference cavity 30 can be compatible with ultra-high stability cavity designs as known in the state of the art (see, e.g., Y. Y. Jiang et al., “Making optical atomic clocks more stable with 10⁻¹⁶-level laser stabilization,” Nature Photonics, volume 5, pp. 158-161 (2011)) and can be made at relatively low cost.

As shown in FIG. 10D, both the reflector 420 and the beam splitting mirror 422 can be concentric with one another and the input (solid arrow) from the main laser cavity 20 can enter through the beam splitting mirror 422 at an angle α/2 from the principal axis of the beam splitting mirror 422 and can impinge onto the reflector 420 at an offset d from the principal axis. The reflector 420 can then be configured to reflect the input beam back on itself; the beam transmitted by the beam splitting mirror 422 can then go back to the main cavity 22, whereas the beam reflected (dashed arrow) at the beam splitting mirror 422 can propagate back to the reflector 420 at an angle −α/2 and can impinge onto the reflector 420 at an offset −d. The reflection from the reflector 420 can then also be reflected back onto itself and can be directed back to the beam splitting mirror 422 and the process can repeat. The beam transmitted at the beam splitting mirror 422 can be the transmitted output beam, as described herein with regard to FIGS. 10A-10C. The two-mirror V-shaped cavity 30 shown in FIG. 10D can constitute a reference cavity 30 with improved mechanical stability that can be used for ultra-stable harmonic modelocking. Moreover, a two-mirror V-shaped cavity 30 can also be used for other applications, for example, as an improvement to the construction of reference cavities as used for line narrowing of cw diode lasers, as discussed by N. Jobert et al. In certain other implementations of a two-mirror V-shaped cavity 30, one of the reflector 420 and the beam splitting mirror 422 can be curved, and the other can be flat. Certain such implementations can use at least one mirror that has a highly reflective (HR) coating on its periphery and that is partially transmissive in the central section. The reflector 420 and the beam splitting mirror 422 can be optically contacted to a spacer material with a central area removed to allow for beam propagation in air or in vacuum.

Ultra-stable reference cavities can also be constructed without intra-cavity actuators, however, the main cavity 22 can be locked to the reference cavity 30 with the inclusion of actuators into the main cavity 22 or in the beam path between main cavity 22 and the reference cavity 30. For example, when providing a high bandwidth EO modulator in the main cavity 22, as discussed herein with respect to FIG. 6, the cavity length can be modulated at a frequency of several MHz; detection of the output of the reference cavity 30 and mixing the output signal with the modulation signal can then produce an error signal for matching the length of the main cavity 22 to the reference cavity 30 (e.g., similar to Pound-Drever-Hall cavity locking techniques). In certain implementations, the f_{ceo} of the signal can then, for example, be controlled by controlling the pump power to the fiber amplifier that is part of the main cavity 22. Other configurations are also possible.

The example reference cavities 30 shown in FIGS. 10A-10C can be configured for the construction of a HML pulse source which does not utilize f_{beat} or f_{ceo} control and that uses a standard silica substrate to save costs. To allow for locking of the repetition rate of such a source to an external microwave reference, at least one of the first and second mirrors 36a,b and the beam splitter 32 can be mounted onto a PZT for precision cavity length control.

As described herein with regard to FIG. 9E, the HML fiber laser 100 of certain implementations use a reference cavity 30 in conjunction with f_{ceo} locking for control of cavity length mismatch. FIG. 10E schematically illustrates an example HML fiber laser 100 in accordance with certain such implementations described herein. The HML fiber laser 100 comprises a main cavity 440 (e.g., nonlinear-amplifying loop mirror) on the left-hand side comprising an Er gain fiber 442 and a coupler 444 (e.g., 50/50), which is coupled to a V-cavity 450 on the right-hand side (e.g., comprising first and second mirrors 452a,b), utilizing an imaging system (e.g., denoted by lens 454) to focus the output from an intra-cavity pigtail 456 onto the first mirror 452a, which is partially reflective. To facilitate f_{ceo} locking, an output from the HML fiber laser 100 (e.g., extracted by a tap 458) can be directed to an f-2f interferometer (not shown). In certain implementations, at least one PZT fiber stretcher 446 is included for length control of the main cavity 440. PZT stretchers 446 with different actuation bandwidth can be readily implemented. The HML fiber laser 100 of FIG. 10E further comprises a pump laser 448 and a wavelength-division multiplexer (WDM) 449.

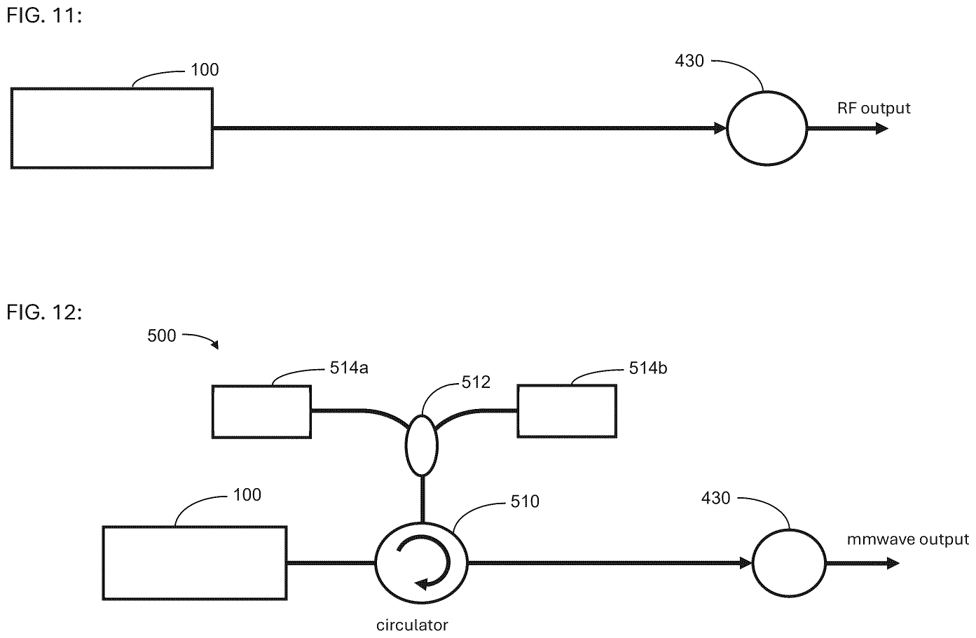

In certain implementations with f_{ceo} locking (e.g., via control of the pump current), the relative cavity length between the V-cavity 450 and the main cavity 440 can also be stabilized. As a result, the main cavity 440 can take on the stability of the V-cavity 450 and produce an output pulse train with ultra-highly stable repetition rate. With a V-cavity 450 comprising ultra-low expansion materials (e.g., ULER or Zerodur® glass), the stability of the repetition rate can be better than 1×10⁻¹⁵ in 1 second. The stability can be further optimized by inserting at least the V-cavity 450 in a vacuum chamber. The linewidth of the comb modes can further be reduced (e.g., minimized) by implementing a relatively high reflectivity for the first mirror 452a (e.g., greater than 70%) and optimizing the location of the f_{ceo} frequency in frequency space. In certain implementations, the individual comb linewidth are less than 1 kHz (e.g., less than 100 Hz; less than 10 Hz; substantially lower than possible with standard frequency combs). In certain implementations, f_{beat} locking is not utilized since the comb modes are intrinsically locked to the reference cavity 30. The example HML fiber laser 100 shown in FIG. 10E is particularly attractive for ultra-low-noise microwave generation, as described with respect to FIG. 11.

In certain implementations, a V-cavity 450 as shown in FIGS. 10D and 10E or a reference cavity 30 as shown in FIGS. 3A and 3B may be non-optimal for generation of very high repetition rates, as some applications also utilize ultra-high bandwidth control of the cavity length. FIG. 10F schematically illustrates an example HML fiber laser 100 in which the V-cavity 450 of FIG. 10E or the reference cavity 30 of FIGS. 3A and 3B is replaced with a monolithic V-cavity 470 (e.g., operatively integrated with an electro-optic modulator) in accordance with certain implementations described herein. FIG. 10G schematically illustrates an example monolithic V-cavity 470 in accordance with certain implementations described herein. FIG. 10F schematically illustrates a top view of the monolithic V-cavity 470 of FIG. 10G. In certain implementations, the monolithic V-cavity 470 can be fabricated from a block of an electro-optic material such as a crystal of lithium niobate (LN). As shown in FIG. 10G, the input polarization of the incoming light and the optic axis of the electro-optic material can be parallel to each other. Electrodes (not shown) can be deposited on the top and bottom of the electro-optic material to enable electro-optic modulation by applying a voltage which produces an electric field in the same direction as the optical axis of the electro-optic material. As a result, a rapid modulation of the optical path length within the electro-optic material can be produced, which can be used for high bandwidth f_{ceo} or f_{beat} control (e.g., utilizing additional detectors, as described with regard to FIG. 3B, and additional feedback loops). The resulting actuation bandwidths can be of the order of 1 MHz and even higher, which can reduce (e.g., minimize) timing jitter and/or phase noise of the f_{ceo} or f_{beat} signal derived from the HML fiber laser 100.

The optical beam path inside the monolithic V-cavity 470 can be similar to that of the V-shaped reference cavity 30 of FIG. 10D or the V-cavity 450 of FIG. 10E. The front mirror can be flat and the input from the main cavity 22 can enter the monolithic V-cavity 470 at an angle α/2 from the surface normal. The refraction of the input beam at the front mirror surface of the crystal is omitted here for simplicity. After reflection from the curved back crystal surface of the monolithic V-cavity 470, the beam transmitted by the front surface can go back to the main cavity 22, whereas the beam reflected at the front surface can propagate back to the curved surface at an angle −α/2 to impinge onto the curved surface. The reflection from the curved back surface can then also be reflected back onto itself and can be directed back to the front surface and the process can repeat. FIG. 10G schematically illustrates a lithium niobate crystal with a flat front surface and a back surface shaped as a cylindrical lens, which can be straight-forward to manufacture. In certain other implementations, a spherical back surface and a spherical front surface can be used. The HML fiber laser 100 shown in FIG. 10F can be particularly useful for the generation of very high repetition rates (e.g., in the range from 1 GHz to 10 GHz; or even higher), where the insertion of a separate electro-optic crystal for high bandwidth cavity length modulation of a reference cavity 30 is difficult.

Frequency references based on HML fiber lasers 100 as described herein can have many applications, for example, the output of the HML fiber laser 100 can be used for ultra-low noise microwave generation, as shown in FIG. 11. The optical output of the HML fiber laser 100 can be a frequency reference that is directed onto a high saturation current photodetector 430 (e.g., uni-traveling-carrier (UTC) photodiode) which converts the optical pulse train to a microwave signal at the pulse repetition rate and its harmonics. For example, the generation of an ultra-low noise microwave signal at 10 GHz, a HML fiber laser 100 operating at 2.5 GHz can then produce the 10 GHz as the fourth harmonic of the pulse repetition rate. In contrast to RF sources based on previously-disclosed passively modelocked fiber frequency combs (e.g., operating at 250 MHZ), certain implementations described herein do not utilize interleaving of the pulse train, due to the much higher pulse repetition rate of a HML fiber comb. Also, certain implementations described herein do not utilize a cw laser locked to an ultra-high Q reference cavity, since the HML fiber laser 100 can be its own frequency reference. Certain implementations described herein achieve a substantial improvement over previously-disclosed systems (for example, as described in X. Xie, Nature Photonics, vol. 11, pp. 44-47 (2017) or M. Kalubovilage et al., “X-Band photonic microwaves with phase noise below −180 dBc/Hz using a free-running monolithic comb,” Optics Express Vol. 30, Issue 7, pp. 11266-11274 (2022)). In certain implementations, the HML fiber laser 100 described herein provides superior ultra-low noise performance at low frequency offsets and a compact system construction, while at the same time reducing (e.g., minimizing) the use of optical amplification and pulse interleaving with the associated noise issues (e.g., which are used in both the Xie et al. and Kalubovilage et al. systems).

In certain implementations, higher microwave frequencies can be generated by filtering out higher harmonics of the pulse repetition rate or by filtering out appropriate optical comb lines and interfering them on a photo-detector. FIG. 12 schematically illustrates an example mm wave source 500 based on a HML fiber laser 100 as described herein. In certain implementations, the frequency reference output of the HML fiber laser 100 can be directed to a circulator 510 and split into two parts by a coupler 512. The two parts can then be used to injection lock two different laser diodes 514a,b (e.g., two different distributed feedback (DFB) lasers), which can select and amplify two different comb lines, which are then recombined and directed through the circulator 510 and finally interfered on the photodetector 430, which can convert the beat signal to the mm wave or THz frequency domain.

In certain implementations, the HML fiber laser 100 can act as a universal frequency synthesizer for ultra-low noise microwave and mm wave frequencies. The synthesis of optical frequencies can be equally possible using a set-up as shown in FIG. 12, where only one laser diode can be used for frequency selection and amplification. Frequency tuning of the optical synthesizer can be performed by using actuators inside the HML fiber laser 100. The operation of previously-disclosed modelocked fiber lasers as universal frequency synthesizers is much more difficult, due to the small comb spacing and much lower power per mode. In certain implementations, the universal frequency synthesizer described herein provides improved performance as compared to previously-disclosed systems.

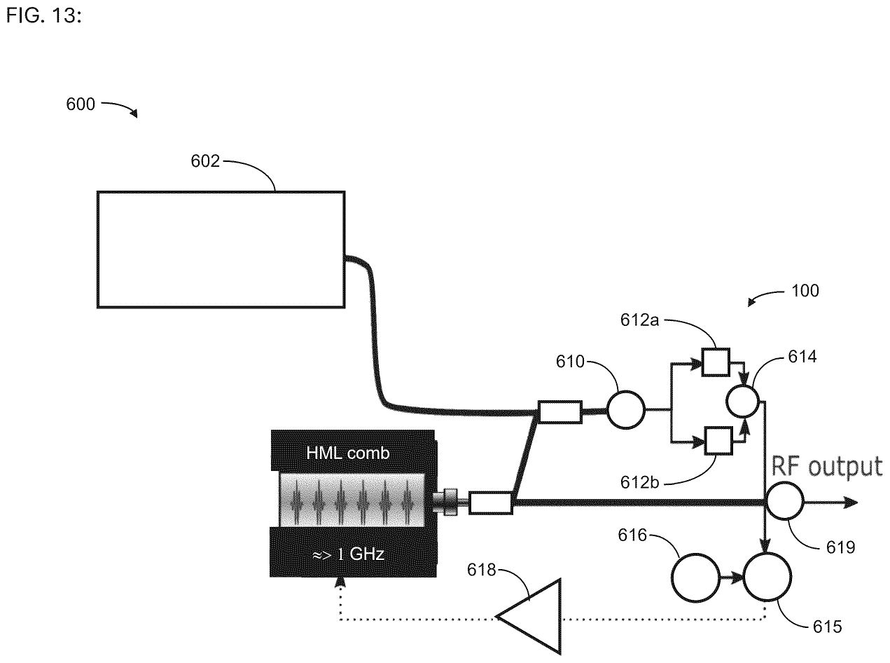

In certain implementations, frequency down conversion from the mm wave frequency range (e.g., 100 GHz to 1 THz) to the microwave range can also be of interest. Such frequency down-conversion systems are disclosed in U.S. Pat. No. 11,409,185 to Kuse et al. and the use of a HML fiber laser 100 as described herein can be used for frequency down-conversion. FIG. 13 schematically illustrates an example system 600 for a frequency down-converter, converting a mm wave signal to a micrometer wave signal based on a HML fiber laser 100 in accordance with certain implementations described herein.

The input to the down-converter can be obtained from two optical cw nodes 602 (e.g., laser wavelengths) separated by the desired frequency spacing, for example in the range from 100 GHz to a few THz. In order to down convert the millimeter-wave beat note to the RF domain, the HML fiber laser 100 can be operated at a repetition rate of about 1 GHz to a few GHz. To phase lock the HML fiber laser 100 to the millimeter-wave beat note, for example, a photodetector 610 can detect the two beats of the two cw nodes with nearest neighbor comb lines from the HML fiber laser 100.

The two beats can be filtered in the RF domain by two RF bandpass filters (RFBP) 612a,b. The two beats can be subsequently mixed by a mixer 614, generating a secondary beat signal. The mixer 614 can reduce or eliminate the carrier envelope offset frequency of the HML fiber laser 100 from the secondary beat signal. The secondary beat signal can then be mixed by a mixer 615 with a local oscillator 616 (e.g., at a frequency of 10 MHZ), generating an error signal via a PID controller 618 which is fed back to a repetition rate controller in the HML fiber laser 100 (e.g., the PZT and EOM inside the reference cavity 30, as shown in FIG. 9E). The intermodal beat frequency from the HML fiber laser 100 can be detected with a photodetector 619 and can generate an ultra-stable output at the repetition rate of the HML fiber laser 100. In certain such implementations, the two wavelengths from the two cw nodes separated by hundreds of GHz are used to stabilize the repetition rate of the HML fiber laser 100. Therefore the repetition rate of the HML fiber laser 100 can carry the differential phase noise of the two cw nodes with a frequency separation of hundreds of GHz. In other words, the frequency stability of the HML repetition rate can be the same (or nearly the same) as the stability of the difference frequency between the two cw nodes separated by hundreds of GHz.

In certain implementations, a HML fiber laser 100 is used for dual comb spectroscopy, since the built-in reference cavity 30 can greatly improve the stability of the output pulse train. In addition, operation at GHz repetition rates can improve the signal acquisition speed for dual comb spectroscopy as compared to conventional modelocked fiber combs operating at a mode spacing in the 100 MHz to 200 MHz range. In certain implementations, two HML fiber combs operating at slightly different repetition rates can be configured for efficient dual comb spectroscopy. Dual comb systems are described in U.S. Pat. No. 8,699,532 to Fermann et al.

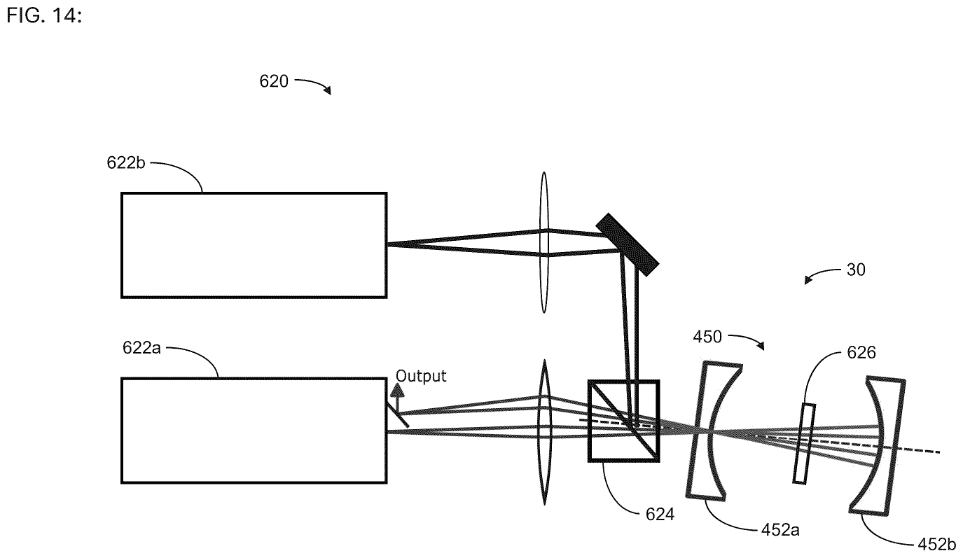

In certain implementations, a HML fiber laser 100 uses only one reference cavity 30 for dual comb operation, which can reduce the differential noise between two HML combs via common mode noise suppression. FIG. 14 schematically illustrates an example system 620 with two HML fiber combs (e.g., first fiber comb 622a and second fiber comb 622b) referenced to a common reference cavity 30 in accordance with certain implementations described herein. For example, the two fiber combs 622a,b can be constructed as described with respect to FIG. 10E. The fiber combs 622a,b can be configured to operate on two different polarization axes, thus allowing for simultaneous coupling of both combs 622a,b into a common reference cavity 30 via a polarization beam splitter (PBS) 624. The reference cavity 30 (e.g., V-cavity 450) can include a birefringent optic (BO) 626 (e.g., a waveplate), to ensure operation of the two combs 622a,b at slightly different repetition rates.

In certain implementations, the HML fiber laser 100 can provide dual comb operation with a common fiber cavity as well as a common reference cavity 30, which can further reduce the differential noise between the two HML combs 622a,b via common mode noise suppression. For example, dual comb operation in a single fiber cavity was described in P. E. Collin Aldia, “Detection of carbon monoxide using a polarization multiplexed erbium dual-comb fiber laser,” Journal of Physics: Photonics, vol. 6, (2024) 045017. However, this system was susceptible to noise from non-common mode fiber sections and no provisions for HML or common mode noise suppression via an integrated reference cavity were suggested.

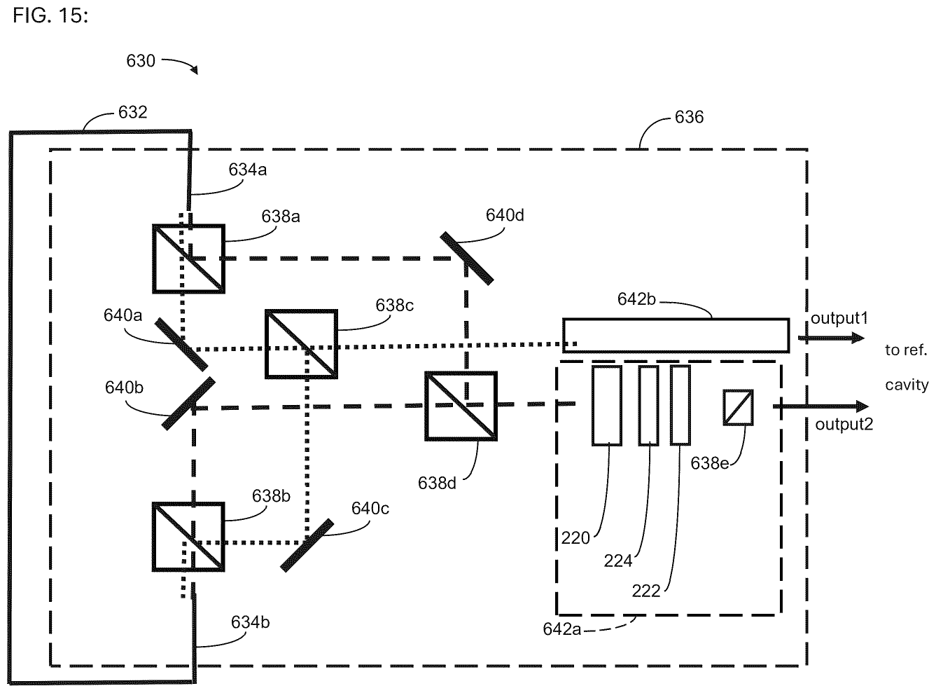

FIG. 15 schematically illustrates an example configuration 630 for two common HML fiber combs 622a,b referenced to a common reference cavity 30 in accordance with certain implementations described herein. FIG. 15 is essentially a combination of the HML fiber laser 100 shown in FIG. 5 with the example system 620 shown in FIG. 14. The configuration 630 comprises two main fiber cavities operating along orthogonal polarization directions constructed from a single polarization maintaining fiber loop 632. The fiber loop 632 also comprises a fiber amplifier (not shown) for laser oscillation. For simplicity, FIG. 15 shows the fiber loop 632 as a line connecting the two pigtail ends 634a,b of the fiber loop 632 (e.g., drawings of couplers, fiber amplifiers, or fiber stretchers inside the loop are omitted). As shown in FIG. 15, the pigtail ends are connected upstream of the pigtail ends 634a,b to make the fiber loop 632. The output of the two pigtail ends 634a,b can be collimated and directed into a polarization splitting sub-assembly (PSSA) 636. The PSSA 636 contains a plurality of polarization beam splitters (PBSs) 638 and a plurality of mirrors 640. A first PBS 638a splits the two polarizations propagating clock-wise in the fiber loop 632 into its polarization components P1+ and P2+, whereas a second PBS 638b splits the two polarizations propagating counter clock-wise in the fiber loop 632 into its polarization components P1− and P2−. P1+ and P2− are subsequently polarization combined via a fourth PBS 638d and P2+ and P1− are subsequently polarization combined via a third PBS 638c. By positioning the first PBS 638a, a first mirror 640a, a fourth mirror 640d, and the fourth PBS 638d appropriately, the optical path lengths of P1+ and P2− (e.g., from the fourth PBS 638d along the fiber loop 632 and back to the fourth PBS 638d) can be approximately equal. Hence P1+ and P2− can interfere nonlinearly at a fifth PBS 638e to induce short pulse formation, using a first polarization control assembly 642a (see, e.g., FIG. 5).

Similarly, P2+ and P1− can interfere nonlinearly to induce short pulse formation in an orthogonal polarization using a second polarization control assembly 642b comprising another set of Faraday rotator, half-wave plate, quarter wave plate, and polarization beam splitter (not shown). In FIG. 15, the optical beam paths of P1+ and P2− are depicted as long dashed lines, whereas the optical beam paths of P2+ and P1− are depicted as dotted lines.

In certain such implementations, the example configuration 630 can be modelocked simultaneously along two different polarization directions with slightly different repetition rates. The PSSA 636 can be made with micro-optics components resulting in a very small form factor.

The PSSA 636 can produce two outputs, output 1 and output 2, which can be configured to have orthogonal polarizations. As discussed with respect to FIG. 14 (and not shown in FIG. 15), the two polarization directions can be combined via a beam splitter and coupled into a single reference cavity including a birefringent optic (BO) to generate two frequency combs operating at slightly different repetition rates for dual comb spectroscopy. To ensure that the optical path lengths of the two different polarization directions coupled into the single reference cavity are appropriate harmonics of the path length inside the reference cavity, additional delay stages (not shown) between the third PBS 638c and the second polarization control assembly 642b and between the fourth PBS 638d and the first polarization control assembly 642a can be inserted. Since the example configuration 630 can benefit from common-mode noise suppression in both the fiber loop 632 and the reference cavity 30, the example configuration 630 can be utilized for dual comb spectroscopy with minimal stabilization of the differential f_{ceo} and fᵣₑₚ of the two combs 622a,b.

In certain implementations, an output wavelength from a HML fiber laser 100 different from the constraints of the gain material can be used (e.g., utilizing nonlinear wavelength conversion). In HML fiber lasers 100 as disclosed here, wavelength conversion can be conveniently put into effect when using the reference cavity 30 as an optical parametric oscillator (OPO). A HML fiber laser 100 can be configured as an OPO by adding a nonlinear crystal, such as periodically poled lithium niobate, curved mirrors to establish a focus inside the nonlinear crystal, and an optic for producing output from the OPO, and selecting appropriate optical materials and coatings for the wavelengths involved.

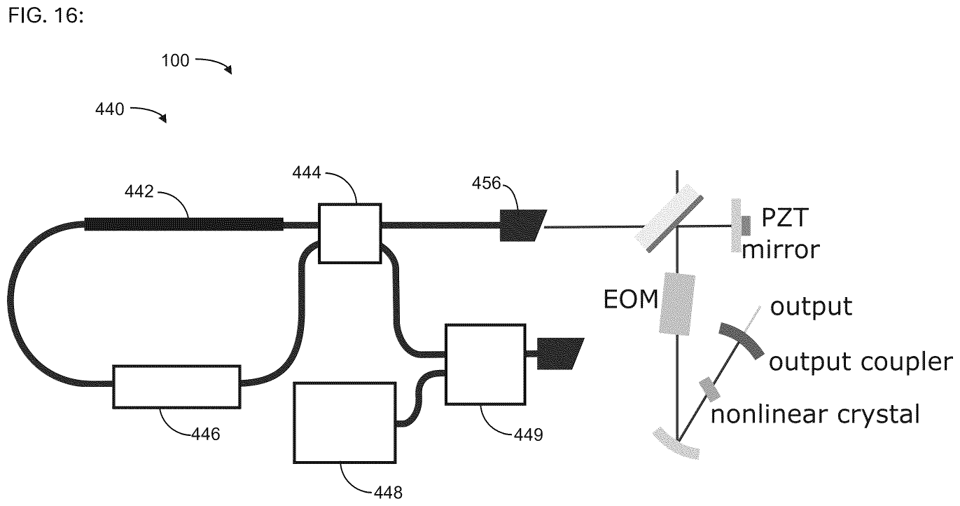

FIG. 16 schematically illustrates an example HML fiber laser 100 configured as an OPO in accordance with certain implementations described herein. The reference cavity beamsplitter can be arranged to avoid passage through a substrate within the reference cavity. For a nonlinear crystal made of lithium niobate, a fast actuator in the form of an EOM made of lithium niobate can also be added to the reference cavity. Such an EOM can transmit the same wavelengths as the nonlinear crystal. In certain implementations, stable operation can also be obtained without an EOM. In FIG. 16, an output coupler can be a coated end mirror, configured to pass some converted light. Compared to other intracavity OPOs, certain implementations can allow different OPO and main laser cavity lengths, higher intensity in the OPO cavity than in the main laser cavity, and can utilizes a pump beam that is already resonant with the OPO cavity for the harmonic modelocking.

While various example implementations described herein can be based on erbium doped fiber amplifiers, other fiber amplifier materials can be equally used in accordance with certain implementations described herein (e.g., fiber amplifiers comprising Yb, Tm and Nd). In certain implementations, harmonically modelocked frequency combs as disclosed here can also be constructed from bulk solid state lasers or semiconductor diode lasers (e.g., a solid state or semiconductor gain medium).

Example, non-limiting experimental data are included herein to illustrate results achievable by various implementations of the systems and methods described herein. All ranges of data and all values within such ranges of data that are shown in the figures or described in the specification are expressly included in this disclosure. The example experiments, experimental data, tables, graphs, plots, figures, and processing and/or operating parameters (e.g., values and/or ranges) described herein are intended to be illustrative of operating conditions of the disclosed systems and methods and are not intended to limit the scope of the operating conditions for various implementations of the methods and systems disclosed herein. Additionally, the experiments, experimental data, calculated data, tables, graphs, plots, figures, and other data disclosed herein demonstrate various regimes in which implementations of the disclosed systems and methods may operate effectively to produce one or more desired results. Such operating regimes and desired results are not limited solely to specific values of operating parameters, conditions, or results shown, for example, in a table, graph, plot, or figure, but also include suitable ranges including or spanning these specific values. Accordingly, the values disclosed herein include the range of values between any of the values listed or shown in the tables, graphs, plots, figures, etc. Additionally, the values disclosed herein include the range of values above or below any of the values listed or shown in the tables, graphs, plots, figures, etc. as might be demonstrated by other values listed or shown in the tables, graphs, plots, figures, etc. Also, although the data disclosed herein may establish one or more effective operating ranges and/or one or more desired results for certain implementations, it is to be understood that not every implementation need be operable in each such operating range or need produce each such desired result. Further, other implementations of the disclosed systems and methods may operate in other operating regimes and/or produce other results than shown and described with reference to the example experiments, experimental data, tables, graphs, plots, figures, and other data herein.

The invention has been described in several non-limiting implementations. It is to be understood that the implementations are not mutually exclusive, and elements described in connection with one implementation may be combined with, rearranged, or eliminated from, other implementations in suitable ways to accomplish desired design objectives. No single feature or group of features is necessary or required for each implementation.

For purposes of summarizing the present invention, certain aspects, advantages and novel features of the present invention are described herein. It is to be understood, however, that not necessarily all such advantages may be achieved in accordance with any particular implementation. Thus, the present invention may be embodied or carried out in a manner that achieves one or more advantages without necessarily achieving other advantages as may be taught or suggested herein.

As used herein any reference to “one implementation” or “some implementations” or “an implementation” means that a particular element, feature, structure, or characteristic described in connection with the implementation is included in at least one implementation. The appearances of the phrase “in one implementation” in various places in the specification are not necessarily all referring to the same implementation. Although commonly used terms are used to describe the systems and methods of certain implementations for case of understanding, these terms are used herein to have their broadest reasonable interpretations. Although various aspects of the disclosure are described with regard to illustrative examples and implementations, the disclosed examples and implementations should not be construed as limiting. Conditional language used herein, such as, among others, “can,” “could,” “might,” “may,” “e.g.,” and the like, unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. In addition, the articles “a” or “an” or “the” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

Thus, while only certain implementations have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the implementations described therein.

1. The apparatus according to claim 22, wherein the apparatus comprises:
a harmonically modelocked laser comprising the first cavity and the second cavity.

2. (canceled)

3. (canceled)

4. The apparatus according to claim 1, wherein the first cavity comprises a bulk reference cavity, a fiber reference cavity, and/or a combination of fiber and bulk optic components.

5. (canceled)

6. (canceled)

7. The apparatus according to claim 1, further comprising an electro-optic modulator.

8. The apparatus according to claim 1, further comprising at least one actuator for controlling a cavity mismatch between the first cavity and the second cavity.

9. The apparatus according to claim 8, wherein the at least one actuator is configured to be driven by an error signal derived from an optical spectrum of the harmonically modelocked laser.

10. The apparatus according to claim 8, wherein the at least one actuator is configured to be driven by an error signal derived from an f_{ceo} signal generated by the harmonically modelocked laser.

11. (canceled)

12. The apparatus according to claim 1, wherein the at least one optical beam splitter has a reflectivity greater than 15%.

13. The apparatus according to claim 1, wherein the at least one optical beam splitter has a reflectivity less than 10%.

14. The apparatus according to claim 1, where N is greater than 11.

15. The apparatus according to claim 1, wherein the harmonically modelocked laser is configured to operate at a repetition rate greater than 1 GHz.

16. The apparatus according to claim 1, wherein the second cavity comprises an optical spacer based on ultra-low thermal expansion material.

17. The apparatus according to claim 1, wherein the output comprises ultra-high stability microwaves and/or ultra-high stability mm waves.

18. (canceled)

19. (canceled)

20. The apparatus according to claim 1, wherein the second cavity comprises a micro-resonator and/or a fiber knot resonator.

21. (canceled)

22. An apparatus comprising:
a first cavity with a first cavity round trip time T and a second cavity with a second cavity round trip time T/N, where N is an integer, the first and second cavities coupled to one another; and
at least one optical beam splitter within the second cavity, the at least one optical beam splitter configured to create a common mode substantially shared between the first and second cavities and to produce an output for an optical frequency comb.

23. (canceled)

24. The apparatus according to claim 22, wherein the first cavity or the second cavity comprises is a monolithic bulk reference cavity.

25. The apparatus according to claim 22, further comprising at least one actuator to lock a repetition rate of the apparatus to an external microwave frequency reference.

26. The apparatus according to claim 22, wherein the apparatus comprises a fiber gain medium.

27. (canceled)

28. An optical cavity comprising:
a first cavity mirror and a second cavity mirror, the first and second cavity mirrors concentric around a principal axis;
an input beam impinging the first cavity mirror at a first angular offset from the principal axis; and
an output beam transmitted through the first cavity mirror at a second angular offset from the principal axis, the second angular offset substantially equal to a negative of the first angular offset, wherein the optical cavity is configured as an element of a modelocked laser.

29. An optical cavity according to claim 28, wherein the optical cavity is further configured as a reference for a modelocked laser.

30. An optical cavity according to claim 28, wherein one of the first and second cavity mirrors is curved and defines the principal axis, and another of the first and second cavity mirrors is substantially flat.

31. An optical cavity according to claim 28, wherein both the first and second cavity mirrors are curved.

32. (canceled)

33. (canceled)

34. (canceled)

35. (canceled)

36. An optical parametric oscillator, comprising:
a modelocked pump laser oscillating at a pump laser wavelength, the modelocked pump laser comprising a first cavity with a first cavity round trip time T and a second cavity with a second cavity round trip time T/N, where N is an integer, the first and second cavities optically coupled to one another, wherein the second cavity further comprises a nonlinear crystal, the second cavity configured to generate an output at a wavelength that is different from the pump laser wavelength.

37. (canceled)
